(19) United States
(12) Patent Application Publication
(10) Pub. No.: US 2006/0178833 A1
(43) Pub. Date: Aug. 10, 2006

(54) System for and method of providing diagnostic information through microscopic imaging

(76) Inventors: Kenneth D. Bauer, San Clemente, CA (US); Scott Webster, Mission Viejo, CA (US)

Correspondence Address: FISH & RICHARDSON, PC, P.O. BOX 1022, MINNEAPOLIS, MN, 55440-1022, US

(21) Appl. No.: 11/050,912

(22) Filed: Feb. 4, 2005

(51) Int. Cl. G06F 19/00

(52) U.S. Cl. 702/19

(57) ABSTRACT

A method and apparatus for automated analysis of chromagenic and fluorescently labeled biological samples, wherein the apparatus automatically scans at a low magnification to acquire images which are analyzed to determine candidate cell objects of interest. Once candidate objects of interest are identified, further analysis can be conducted automatically to process and collect data from samples having different staining reagents.

### TECHNICAL FIELD

This disclosure relates to the identification of specific known objects or fragments of objects within a biological sample, and further to analysis of the identified objects to provide critical information regarding disease detection, disease state, and/or drug treatment efficacy.

### BACKGROUND

In the field of medicine, including oncology, the detection, identification, quantification, and characterization of cells of interest such as cancer cells, through testing of biological samples is an important aspect of diagnosis and research. Typically, a biological sample such as bone marrow, lymph nodes, peripheral blood, cerebrospinal fluid, urine, effusions, fine needle aspirates, peripheral blood scrapings or other biological materials are prepared by staining a sample to identify cells of interest.

### SUMMARY

The disclosure relates to the identification of specific known objects or fragments of objects within a biological sample, and further to analysis of the identified objects to provide critical information regarding disease detection, disease state, and/or drug treatment efficacy. In some implementations, a system and a method can detect, through the use of a computer-controlled microscope, the presence and morphology of endothelial cells and/or endothelial progenitor cells in the bloodstream.

### BRIEF DESCRIPTION OF THE DRAWINGS

The above and other features, including various novel details of construction and combinations of parts, will now be more particularly described with reference to the accompanying drawings and pointed out in the claims. It will be understood that particular apparatuses are shown by way of illustration only and not as limitations of the claims. Rather, the principles and features may be employed in varied and numerous implementations without departing from the scope of the claims.

FIG. 1 illustrates a flow diagram of a method of analyzing a sample for specific object data.

FIG. 2 is a perspective view of an exemplary apparatus for automated cell analysis.

FIG. 3 is a block diagram of the apparatus shown in FIG. 2.

FIG. 4 is a block diagram of the system processor of FIG. 3.

FIG. 5 is a plan view of the apparatus of FIG. 2 having the housing removed.

FIG. 6 is a side view of a microscope subsystem of the apparatus of FIG. 2.

FIG. 7 is a flow diagram of the procedure for automatically determining a scan area.

FIG. 8 shows the scan path on a prepared slide in the procedure of FIG. 8.

FIG. 9 shows an enlarged view of a scan area.

FIG. 10A-B illustrates an image of a field acquired in the procedure of FIG. 7, FIG. 10A is a flow diagram of a procedure for determining a focal position. FIG. 10B is a flow diagram of a procedure for determining a focal position for neutrophils stained with Fast Red and counterstained with hematoxylin. FIG. 10C is a flow diagram of a procedure for automatically determining initial focus.

FIG. 11 shows an array of slide positions for use in the procedure of FIG. 10.

FIG. 12 is a flow diagram of a procedure for automatic focusing at a high magnification.

FIG. 13 is a flow diagram of an overview of the process to locate and identify objects of interest in a stained biological sample on a slide.

FIG. 14 is a flow diagram of a procedure for color space conversion.

FIG. 15 is a flow diagram of a procedure for background suppression via dynamic thresholding.

FIG. 16 is a flow diagram of a procedure for morphological processing.

FIG. 17 is a flow diagram of a procedure for blob analysis.

FIG. 18 is a flow diagram of a procedure for image processing at a high magnification.

FIG. 19 illustrates a mosaic of cell images produced by the apparatus.

FIG. 20 is a flow diagram of a procedure for estimating the number of nucleated cells in a field.

FIGS. 21a and 21b illustrate the apparatus functions available in a user interface of the apparatus.

FIG. 22 is a perspective view of another implementation.

### DETAILED DESCRIPTION

The biological mechanisms of many diseases have been clarified by microscopic examination of tissue samples. Histopathological examination has also permitted the development of effective medical treatments for a variety of illnesses. In standard anatomical pathology, a diagnosis is made on the basis of cell morphology and staining characteristics. Tumor samples, for example, can be examined to characterize the tumor type and suggest whether the patient will respond to a particular form of chemotherapy. Microscopic examination and classification of tissue samples stained by standard methods (such as hematoxylin and eosin) has improved cancer treatment significantly.

In the field of medical diagnostics, the detection, identification, quantification and characterization of cells of interest through microscopic examination of biological specimens are important aspects of disease diagnosis and drug efficacy testing. For example, in the field of oncology, recent studies have proposed a possible relationship between the presence of endothelial and/or endothelial progenitor cells in the bloodstream of a subject and the existence of rapidly dividing tumor tissue. Research has shown that, in order to progress beyond a size where diffusion is sufficient as a means for removing waste products and supplying nutrients, certain tumors are capable of stimulating the growth of blood vessels. It is known that such tumors secrete growth factors such as vascular endothelial cell growth factor (VEGF) in order to stimulate angiogenesis and vasculogenesis. This process may be facilitated through the recruitment of endothelial progenitor cells from the bone marrow to the tumor site. Thus, researchers believe that the presence of endothelial and/or endothelial progenitor cells in the circulation may be an indication of tumor growth and metastasis.

While quantities of circulating endothelial cells and/or endothelial progenitor cells alone may indicate the presence of angiogenic tumors in an individual, there is little other information provided by this information. More information regarding the presence of these cells in the circulation of a subject may provide other beneficial diagnostic results. For example, researchers believe that endothelial cells present in the circulation that are also in a state of apoptosis may be an indication of the efficacy of anti-angiogenic drug therapies. However, it is difficult to obtain accurate information about the state of endothelial or endothelial progenitor cells by the use of current techniques and equipment.

Another difficulty that researchers and clinicians face in the study of circulating endothelial cells and/or endothelial progenitor cells is that there are very few cells present in a given sample. Current laboratory techniques, such as flow cytometry, may be used to analyze enriched blood samples as a means of detecting the presence of these cells. Flow cytometry uses laser light projected through a liquid stream that contains cells or other particles. When the laser light strikes the cells, they reflect the light into neighboring detectors. These signals provide information about various cellular properties and are converted for computer storage and data analysis. However, flow cytometry may require large samples in order to provide an accurate assessment of cellular qualities and it does not provide images of the detected cells themselves for further evaluation.

Another tissue analysis technique that may be used to detect the presence and state of endothelial cells in a sample is microscopic examination of samples. Typically, this technique begins with a biological specimen (e.g., bone marrow or blood) that has been prepared by staining to identify cells of interest. A highly trained technician or clinician then manually views the sample under various magnifications to look for cells of interest. Cells of interest are identified by characteristic staining of cellular features useful in diagnosing certain disease states. While this technique can provide valuable information not available through the use of techniques such as flow cytometry, it is time consuming and error prone, especially when the cells of interest are scarce (i.e., rare) within the sample.

What is needed is a means of efficiently analyzing various biological samples for the presence and state of specific target objects of interest (e.g., endothelial cells, endothelial progenitor cells, and apoptotic endothelial cells and/or progenitor cells), in order to detect and monitor various pathologies and determine drug efficacy. What is also needed is a method to extract accurate object information by the use of a minimum amount of sample and a minimum number of steps required by an operator in order to reduce errors and limit sample use and acquisition.

Thus, in some implementations, the invention can provide a system for and method of analyzing targeted objects or fragments of objects to accurately detect pathologies by the use of a minimum amount or number of samples and a minimum number of steps required by an operator.

In some implementations, the invention can also provide a system for and method of analyzing targeted objects or fragments of objects to accurately monitor various pathological states by the use of a minimum amount or number of samples and a minimum number of steps required by an operator.

In some implementations, the invention can also provide a system for and method of analyzing targeted objects or fragments of objects to accurately measure drug efficacy by the use of a minimum amount or number of samples and a minimum number of steps required by an operator.

In some implementations, the invention can also provide a system for and method of detecting the presence of circulating endothelial and/or endothelial progenitor cells in a sample by the use of an automated microscope imaging system. The data obtained provides information regarding the presence and/or state of development of certain cancerous tumors, as well as a means for monitoring the efficacy therapeutic regimens in the treatment of a disease or disorder associated with endothelial progenitor cells. The analysis is performed on a biological sample by the use of an automated microscope imaging system. An example of such a system includes the Automated Cellular Imaging System (ACIS®) made by ChromaVision Medical Systems, Inc. An example of certain implementations of the ACIS system is provided herein.

A biological sample and/or subsample comprises biological materials obtained from or derived from a living organism. Typically a biological sample will comprise proteins, polynucleotides, organic material, cells, tissue, and any combination of the foregoing. Such samples include, but are not limited to, hair, skin, tissue, cultured cells, cultured cell media, and biological fluids. A tissue is a mass of connected cells and/or extracellular matrix material (e.g., CNS tissue, neural tissue, eye tissue, placental tissue, mammary gland tissue, gastrointestinal tissue, musculoskeletal tissue, genitourinary tissue, and the like) derived from, for example, a human or other mammal and includes the connecting material and the liquid material in association with the cells and/or tissues. A biological fluid is a liquid material derived from, for example, a human or other mammal. Such biological fluids include, but are not limited to, blood, plasma, serum, serum derivatives, bile, phlegm, saliva, sweat, amniotic fluid, mammary fluid, and cerebrospinal fluid (CSF), such as lumbar or ventricular CSF. A sample also may be media containing cells or biological material.

In one implementation, a biological sample may be divided into two or more additional samples (e.g., subsamples). Where an individual sample is a tissue sample used to prepare a subsample, the sample is embedded in embedding media such as paraffin or other waxes, gelatin, agar, polyethylene glycols, polyvinyl alcohol, celloidin, nitrocelluloses, methyl and butyl methacrylate resins or epoxy resins, which are polymerized after they infiltrate the specimen. Water-soluble embedding media such as polyvinyl alcohol, carbowax (polyethylene glycols), gelatin, and agar, may be used directly on specimens. Water-insoluble embedding media such as paraffin and nitrocellulose require that specimens be dehydrated in several changes of solvent such as ethyl alcohol, acetone, or isopropyl alcohol and then be immersed in a solvent in which the embedding medium is soluble. In the case where the embedding medium is paraffin, suitable solvents for the paraffin are xylene, toluene, benzene, petroleum, ether, chloroform, carbon tetrachloride, carbon bisulfide, and cedar oil. Typically a tissue sample is immersed in two or three baths of the paraffin solvent after the tissue is dehydrated and before the tissue sample is embedded in paraffin. Embedding medium includes, for examples, any synthetic or natural matrix suitable for embedding a sample in preparation for tissue sectioning.

A tissue sample can be a conventionally-fixed tissue sample, tissue samples fixed in special fixatives, or may be an unfixed sample (e.g., freeze-dried tissue samples). If a tissue sample is freeze-dried, it should be snap-frozen. Fixation of a tissue sample can be accomplished by cutting the tissue specimens to a thickness that is easily penetrated by fixing fluid. Examples of fixing fluids are aldehyde fixatives such as formaldehyde, formalin or formol, glyoxal, glutaraldehyde, hydroxyadipaldehyde, crotonaldehyde, methacrolein, acetaldehyde, pyruic aldehyde, malonaldehyde, malialdehyde, and succinaldehyde; chloral hydrate; diethylpyrocarbonate; alcohols such as methanol and ethanol; acetone; lead fixatives such as basic lead acetates and lead citrate; mercuric salts such as mercuric chloride; formaldehyde sublimates; sublimate dichromate fluids; chromates and chromic acid; and picric acid. Heat may also be used to fix tissue specimens by boiling the specimens in physiologic sodium chloride solution or distilled water for two to three minutes. Whichever fixation method is ultimately employed, the cellular structures of the tissue sample can be sufficiently hardened before they are embedded in a medium such as paraffin.

Using techniques such as those disclosed herein, a biological sample comprising a tissue can be embedded, sectioned, and fixed, whereby a-single biopsy can render a plurality of subsamples upon sectioning. As discussed below, such subsamples can be examined under different staining or fluorescent conditions thereby rendering a wealth of information about the tissue biopsy. In one implementation, an array of tissue samples can be prepared and located on a single slide. Each tissue sample in the tissue-microarray may be stained and/or treated the same of differently using both automated techniques and manual techniques (see, e.g., Kononen et al. Nature Medicine, 4(7), 1998; and U.S. Pat. No. 6,103,518, the disclosures of which are incorporated herein by reference).

In another implementation, the biological sample can be a fluid. Fluid samples can be prepared using standard techniques. Such technique include asparciting the fluid under appropriate conditions. The fluid can then be manipulated or aliquoted onto a slide in an amount ranging from a few microliters (e.g., 1-5 microliters) to droplet size amounts (e.g., about 10-20 or 50-100 or 100-500 microliters). The sample is typically combined either before applying to the slide or while on the slide with reagents that stain for specific cellular molecules in the sample. Various reagents, stains and the like are discussed herein.

In another implementation, the invention can provide a method whereby a single biological sample may be assayed or examined in many different ways. Under such conditions a sample may be stained or labeled with a first reagent and examined by light microscopy with transmitted light, reflected light, and/or a combination of light microscopy and fluorescent microscopy. The sample is then stained or labeled with a second reagent and examined by light microscopy and/or a combination of light microscopy and fluorescent microscopy.

The biological sample and/or subsample can be contacted with a variety of reagents useful in determining and analyzing cellular molecules and mechanisms. Such reagents include, for example, polynucleotides, polypeptides, small molecules, and/or antibodies useful in in situ screening assays for detecting molecules that specifically bind to a marker present in a sample. Such assays can be used to detect, prognose, diagnose, or monitor various conditions, diseases, and disorders, or monitor the treatment thereof. A reagent can be detectably labeled such that the reagent is detectable when bound or hybridized to its target marker or ligand. Such means for detectably labeling any of the foregoing reagents include an enzymatic, fluorescent, or radionuclide label.

A marker can be any cell component present in a sample that is identifiable by known microscopic, histologic, or molecular biology techniques. Markers can be used, for example, to distinguish neoplastic tissue from non-neoplastic tissue and/or one cell type from another cell type. Such markers can also be used to identify a molecular basis of a disease or disorder including a neoplastic disease or disorder. Such a marker can be, for example, a molecule present on a cell surface, an over-expressed target protein, a nucleic acid mutation or a morphological characteristic of a cell present in a sample.

A reagent useful in some implementations of the invention can be an antibody. Such antibodies can include intact polyclonal or monoclonal antibodies, as well as fragments thereof, such as Fab and F(ab′)2. For example, monoclonal antibodies are made from antigen containing fragments of a protein by methods well known to those skilled in the art (Kohler, et al., Nature, 256:495, 1975). Fluorescent molecules may be bound to an immunoglobulin either directly or indirectly by using an intermediate functional group.

A reagent useful in some implementations of the invention can also be a nucleic acid molecule (e.g., an oligonucleotide or polynucleotide). For example, in situ nucleic acid hybridization techniques are well known in the art and can be used to identify an RNA or DNA marker present in a sample or subsample. Screening procedures that rely on nucleic acid hybridization make it possible to identify a marker from any sample, provided the appropriate oligonucleotide or polynucleotide reagent is available. For example, oligonucleotide reagents, which can correspond to a part of a sequence encoding a target polypeptide (e.g., a cancer marker comprising a polypeptide), can be synthesized chemically or designed through molecular biology techniques. The polynucleotide encoding the target polypeptide can be deduced from the genetic code. However, the degeneracy of the code must generally be taken into account. For such screening, hybridization is typically performed under in situ conditions known to those skilled in the art.

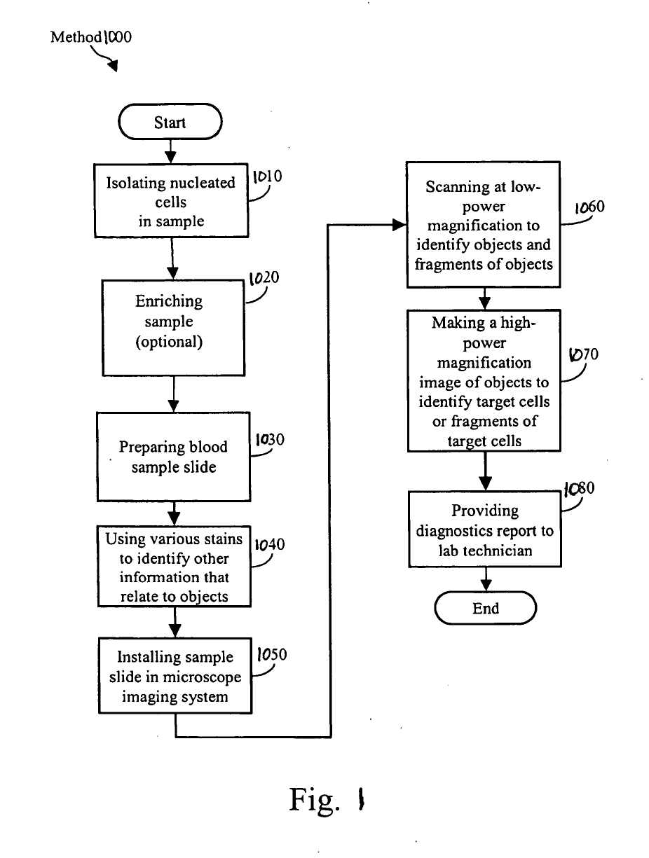

FIG. 1 illustrates a flow diagram of a method 1000 that analyzes areas of interest in order to provide a technician or user additional information, such as types of objects and morphological factors, the state of objects, and/or other important visible information that would help the user make an informed decision regarding a sample. For example, a technician may want to analyze a sample to determine the presence of endothelial and/or endothelial progenitor cells. The technician may also want to know in what quantity the cells are present and whether they are in a state of apoptosis. From this information, a clinician may be able to determine, for example, whether an anti-angiogenic drug is working to treat cancerous tumors or whether cancerous tumors are present and producing VEGF.

Method 1000 includes isolating nucleated cells from a sample 1010 and may optionally include an enrichment step 1020 either before, during or after isolation. A slide of the isolated and/or enriched sample is prepared 1030 and stained or incubated with reagents that identify specific markers or cell-types in the sample 1040. The slide is then loaded 1050 on an imaging system and analyzed 1060 by acquiring an image of the slide using an automated microscope system. As part of the automated image analysis a low magnification image is acquired and candidate object of interest are identified. Such candidate objects can then be further analyzed at a higher magnification 1070. Images and related data (i.e., object of interest count, subject information and the like) are then provided to a clinician or technician 1080.

Methods of isolating 1010 nucleated cells are known in the art and comprise red blood cell lysis and/or gradient separation techniques. Typically the sample is a fluid sample such as blood, serum, cerebrospinal fluid, bile and the like. The technique enriches the sample for nucleated cells including endothelial cells and/or endothelial progenitor cells by density centrifugation techniques and lysis of red blood cells.

Alternatively, or in addition (prior to or subsequent to 1010), the sample can undergo enrichment 1020 using reagents that positively or negatively select for a desired cell type. Such reagents are typically labeled antibodies that recognize markers on cells. For example, a clinician or lab technician may use immunomagnetics or other sample enrichment techniques to increase the concentration of endothelial and/or endothelial progenitor cells in the sample or decrease the concentration of a particular cell type that is not of interest. Such techniques use antibodies (as described more fully below), which recognize makers on cells indicative of a particular cell type (e.g., endothelial cells, endothelial progenitor cells, or non-endothelial cells and/or non-endothelial progenitor cells). These antibodies are capable of binding to markers on a cell. The antibodies themselves-can be bound to magnetic beads that are then used to separate the antibody-bound cells to concentrate them from the sample (e.g., by creating a “sub-sample”). One method employs positive selection and utilizes the binding affinity of antibodies directed to cell surface markers indicative of a desired cell type to purify these cells from other cells. Such techniques may employ column fractionation or affinity purification protocols. An alternative cell enrichment method is negative selection, and is based on the depletion of non-desired cells (e.g., non-endothelial cells) present in a sample. This method utilizes antibodies directed to one or several cell surface markers expressed by non-endothelial/non-endothelial progenitor cells. The negative selection method offers the advantage of not relying on the presence of a endothelial cell surface marker. Using the techniques and compositions described generally above, a method of enriching the number of endothelial cells in a sample using both positive and negative selection sequentially can be used to maximize the sensitivity of the cell detection. Alternatively, each method (positive and negative selections) can be used alone. Markers that can be used (e.g., to enrich and/or to stain cells) comprise CD148, AC133, CD45 and CD34. In one implementation, the sample is enriched for a population of cells that are P1H12⁺, CD 148⁺, AC133⁺, CD 144⁻, CD202b⁻ and VEGFR2⁻. In yet another implementation, an endothelial cell-type includes the markers P1H12⁺, CD144⁺, AC133⁻, CD202⁺, VEGFR2⁺, and contain Weibel-Palade Bodies. Additional markers are provided in Table 1.

TABLE 1

| Type | Name | Target |
|---|---|---|
| Exclusive Endothelial cell | Anti-VE Cadherin (CD144) | Extracellular domain of membrane |
| markers | clone BV6 | protein |
| | Anti-VonWillibrand Factor | blood vessels and tumors |
| | anti-thrombomodulin | surface protein |
| | (CD141) | |
| | Anti-Endothelial cell (PAL-E) | Vascular endothelials but not arteries |
| Non-exclusive Endothelial | Anti-PECAM-1 (CD31) | All endothelials and low level on all |
| specific markers | Clone 390 | platelets and leucocytes |
| | Anti-endothelial cell | Surface intrinsic membrane protein |
| | (CD146) | (melanoma Cell adhesion molecule) |
| | Clone P1H12 | M-CAM, CD146 protein; expressed |
| | | exclusively on normal endothelial |
| | | cells, certain cancers and melanomas. |
| | Anti-PECAM-1 (CD31) | Cultured endothelials, platelets, |
| | Clone WM59 | monocytes and macrophages |
| | Anti-PECAM-1 (CD31) | Cultured endothelials, platelets, |
| | Clone HC1/6 | monocytes and macrophages |
| | Anti-PECAM-1 (CD31) | vascular endothelials, platelets, |
| | Clone P2B1 | monocytes and some T cell lines |
| | Anti-PECAM-1 (CD31) | vascular endothelials and activated |
| | CloneTLD-3A12 | microglial cells |
| | Anti-VEGF Receptor-1 | Endothelial type 1 membrane protein |
| | (FLT-1) | and on common precursors of endothelial |
| | | and hematopoietic stem cells |
| | Anti-VEGF Receptor-2 | Intracellular region of endothelial type |
| | (FLK-1, KDR) | 1 membrane protein and on common |
| | | precursors of endothelial and |
| | | hematopoietic stem cells |
| | Anti-VEGF Receptor-2 | Extracellular domain of endothelial |
| | (FLK-1) | membrane protein tyrosine kinase |
| | Clone 4H3B6H9 | receptor and on common precursors of |
| | | endothelial and hematopoietic stem cells |
| | Anti-VEGF RECEPTOR-3 | C-terminus cytoplasmic domain of |
| | (FLT-4) | endothelial membrane protein |
| | | tyrosine kinase receptor |
| | Anti-TIE-1, C-TERMINUS | Extracellular portion of embryonic endothelial |
| | | and hematopoietic stem cells |
| | TIE-1, N-TERMINUS | Intracellular portion of embryonic endothelial |
| | | and hematopoietic stem cells |
| | TIE-2 Clone 1E11DH, | Extracellular domain of surface receptor |
| | 4G8HE | on actively growing blood vessels |
| | Anti-CD34 Clone: B1-3C5 | Vascular endothelium, precursor cells |
| | | and subsets of CFU-GEMM and BFU- |
| | | E, all CFU-GM, granulocyte precursors, |
| | | monocytes, myeloid leukaemias. |
| | Anti-CD34 | Intracellular domain phosphorylation site |
| | Clone: 581 | |
| | Anti-ICAM-1 (CD54) | Endothelial, dendritic, monocytes, |
| | clone: LTF 653 | lymphocytes |
| | Anti-ICAM-1 (CD54) | Vascular endothelial, peritoneal |
| | clone: 1A29 | macrophages |
| | Anti-p-Selectin GMP140 | Surface of activated platelets and |
| | (CD62P) | vascular endothelial |
| | Anti-Endoglin CD105 | Adult endothelial of blood vessels and |
| | Clone: 8E11 | some leukaemia cells |

The antibodies may be attached to a solid support (e.g., antibody-coated magnetic beads). Examples of commercially available antibodies that recognize lineage dependent markers include anti-AC133 (Miltenyi Biotec, Auburn, Calif.), anti-CD34 (Becton Dickinson, San Jose, Calif.), anti-CD31, anti-CD62E, anti-CD104, anti-CD106, anti-CD1a, anti-CD14 (all available from Pharmingen, Hamburg, Germany); anti-CD144 and anti-CD-13 (Immunotech, Marseille, France). The clone P1H12 (Chemicon, Temecula, Calif.; Catalog Number MAB16985), produces an antibody that specifically reacts with P1H12 antigen (also known as CD146, MCAM, and MUC18). The P1H12 antibody specifically localizes to endothelial cells of all vessels including microvessels of normal and cancerous tissue. The P1H12 antibody does not stain hematopoietic cells.

Procedures for separation may include magnetic separation, using antibody-coated magnetic beads, affinity chromatography, cytotoxic agents joined to a monoclonal antibody, or such agents used in conjunction with a monoclonal antibody, e.g., complement and cytotoxins, and “panning” with antibody attached to a solid matrix (e.g., plate), or other convenient technique. Techniques providing accurate separation include fluorescence activated cell sorters, which can have varying degrees of sophistication, e.g., a plurality of color channels, low angle and obtuse light scattering detecting channels, and impedance channels. As mentioned above, antibodies may be conjugated with markers, such as magnetic beads, which allow for direct separation, biotin, which can be removed with avidin or streptavidin bound to a support, fluorochromes, which can be used with a fluorescence activated cell sorter, or the like, to allow for ease of separation of the particular cell type. Any technique may be employed which is not unduly detrimental to the viability of the stem cells.

In one implementation, magnetic beads linked to antibodies selective for cell surface markers present on a cells of the hematopoietic systems (e.g., T-cells, B-cells, (both pre-B and B-cells and myelomonocytic cells) and/or minor cell populations (e.g., megakaryocytes, mast cells, eosinophils and basophils) are used either prior to, simultaneously with, or subsequent to using, for example, a P1H12 antigen selection. Platelets and erythrocytes can be removed (e.g., by density gradient techniques) prior to sorting or separation of other cell types.

Combinations of enrichment methods may be used to improve the time or efficiency of purification or enrichment. For example, after an enrichment step to remove cells having markers that are not indicative of the cell type of interest the cells may be further separated or enriched by a fluorescence activated cell sorter (FACS) or other methodology having high specificity. Multi-color analyses may be employed with a FACS. The cells may be separated on the basis of the level of staining for a particular antigen or lack thereof. Fluorochromes may be used to label antibodies specific for a particular antigen. Such fluorochromes include phycobiliproteins, e.g., phycoerythrin and allophycocyanins, fluorescein, Texas red, and the like. While each of the lineages present in a population may be separated in a separate step, typically by a negative selection process, typically the cell type of interest (e.g., endothelial cells and/or endothelial cell progenitors) will be separated in one step in a positive selection process.

Although the particular order 1010 and 1020 (see FIG. 1) is not critical, a typical order includes a coarse separation (e.g., density gradient centrifugation), followed by a fine separation (e.g., positive selection of a marker associated with an endothelial cell type (e.g., the P1H12 antigen)). Typically density gradient separation is followed by positive selection for an endothelial cell marker such as P1H12⁺.

Any cell type-specific markers can be used to select for or against a particular cell type. Examples of such markers include CD10/19/20 (associated with B-cells), CD3/4/8 (associated with T-cells), CD14/15/33 (associated with myeloid cells), and Thy-1, which is absent on human T-cells. Also, rhodarmine 123 can be used to divide CD34⁺ cells into “high” and “low” subsets. See Spangrude, 1990, Proc. Natl. Acad. Sci. 87:7433 for a description of the use of rhodamine 123 with mouse stem cells.

Endothelial progenitor cells typically express one or more markers associated with an endothelial stem cell phenotype and/or lack one or more markers associated with a differentiated cell phenotype (e.g., a cell having a reduced capacity for self-renewal, regeneration, or differentiation) and/or a cell of hematopoietic origin. A “marker” of a desired cell type is found on a sufficiently high percentage of cells of the desired cell type, and found on a sufficiently low percentage of cells of an undesired cell type. One can achieve a desired level of purification of the desired cell type from a population of cells comprising both desired and undesired cell types by selecting for cells in the population of cells that have the marker. A marker can be displayed on, for example, 30%, 35%, 40%, 45%, 50%, 55%, 60%, 65%, 70%, 75%, 80%, 85%, 90%, 95%, 99% or more of the desired cell type, and can be displayed on fewer than 50%, 45%, 40%, 35%, 30%, 25%, 20%, 15%, 10%, 5%, 1% or fewer of an undesired cell type. Examples of markers characteristic of a progenitor cell include the P1H12 antigen (also known as MUC18 and CD146; Solovey et al., 2001, J. Lab. Clin. Med. 138:322-31; antibodies recognizing are available from, e.g., CRP Inc., Denver, Pa., cat. no. MMS-470R) and AC133 (Bhatia, 2001, Leukemia 15:1685-88). Examples of markers that are typically lacking on endothelial progenitor cells include CD3 and/or CD14; see Leukocyte Typing VII, Mason et al. (eds), Oxford University Press, 2002, pp. 344-46).

In one implementation, an endothelial progenitor cell is P1H12⁺ and AC133⁺. The progenitor cells also can be CD34 low or CD34⁻, CD148⁺, and/or CD45⁺. The progenitor cells can also lack one or more of the phenotypic markers CD14, CD144, CD202b, and/or VEGRF2. Thus, an endothelial progenitor cell can be P1H12⁺, CD148⁺, AC133⁺, CD34⁺, CD45⁺, CD144⁻, CD202b⁻, and VEGRF2⁻.

The term “precursor cell,” “progenitor cell,” and “stem cell” are used interchangeably in the art and herein and refer either to a pluripotent, or lineage-uncommitted, progenitor cell, which is potentially capable of an unlimited number of mitotic divisions to either renew its line or to produce progeny cells which will differentiate into endothelial cells or endothelial-like cells; or a lineage-committed progenitor cell and its progeny, which is capable of self-renewal and is capable of differentiating into an endothelial cell. Unlike pluripotent stem cells, lineage-committed progenitor cells are generally considered to be incapable of giving rise to numerous cell types that phenotypically differ from each other. Instead, they give rise to one or possibly two lineage-committed cell types.

The term “enriched” or “purified” means a desired cell type is substantially free of cells carrying markers associated with different cell-type lineages. In particular implementations, the desired cell types are enriched at least 30%, 35%, 40%, 45%, 50%, 55%, 60%, 65%, 70%, 75%, 80%, 85%, 90%, 95% or 99% free of other non-desired cell types.

A method of preparing 1030 a sample on a slide uses standard sample fixation techniques to place a portion of the enriched fluid sample from 1010/1020 on a microscope slide, which is to be used by an automated microscope imaging system. The slide is then treated with any number of reagents to identify cell and cell characteristics in the sample 1040. A clinician or technician uses various stains to treat the sample according to the tests to be performed and to identify various features in the sample. For example, endothelial cells (including progenitors) can be detected using immunocytochemical stains comprising CD31, CD146 and vonwillibrand Factor. Other markers that can be used include those described above (e.g., to enrich and/or to stain cells) and include CD148, AC133, CD45 and CD34.

Once the sample has been placed on a slide and treated (e.g., stained) to identify particular cells, morphological features and the like, the slide is loaded 1050 on an automated microscope system. Various automated systems for staining and loading slides are known and are discussed further herein below.

An automated microscope system scans and/or images 1060 the slide comprising the sample to identify candidate objects of interest comprising, for example, endothelial cells, endothelial cell progenitors, apoptotic fragments of endothelial cells or progenitor cells and the like. If a candidate object of interest is identified the coordinates are stored along with an optional image of the candidate object. In one aspect, a higher power image of an identified candidate object of interest is obtained 1070 based upon the previously stored coordinates. Once the slide has been analyzed a report is generated 1080 by the automated imaging system (either before or after 1070). The report may include information regarding the number of candidate object of interest, their overall state (e.g., apoptosis, normal), presence of specific markers and their quantities, morphametric characteristics, and other characteristics or combinations of characteristics). The information provided by the report will provide a clinician or lab technician with key information regarding drug efficacy, as well as pathological detection and monitoring.

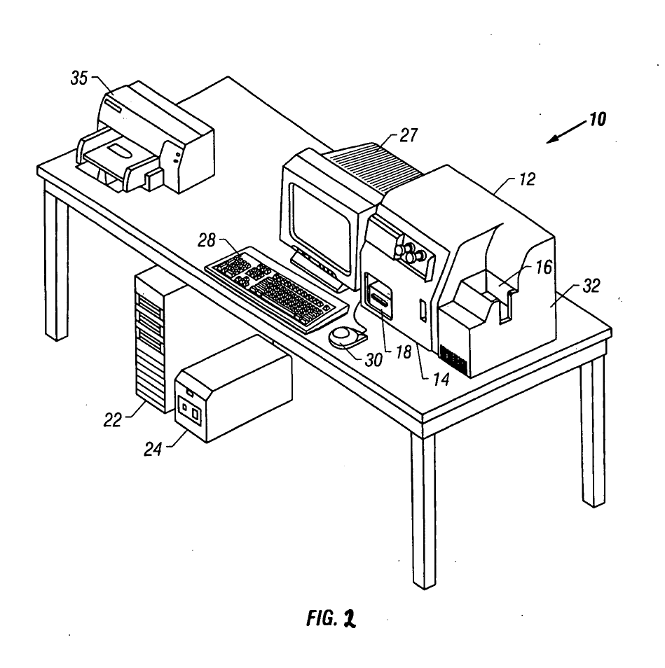

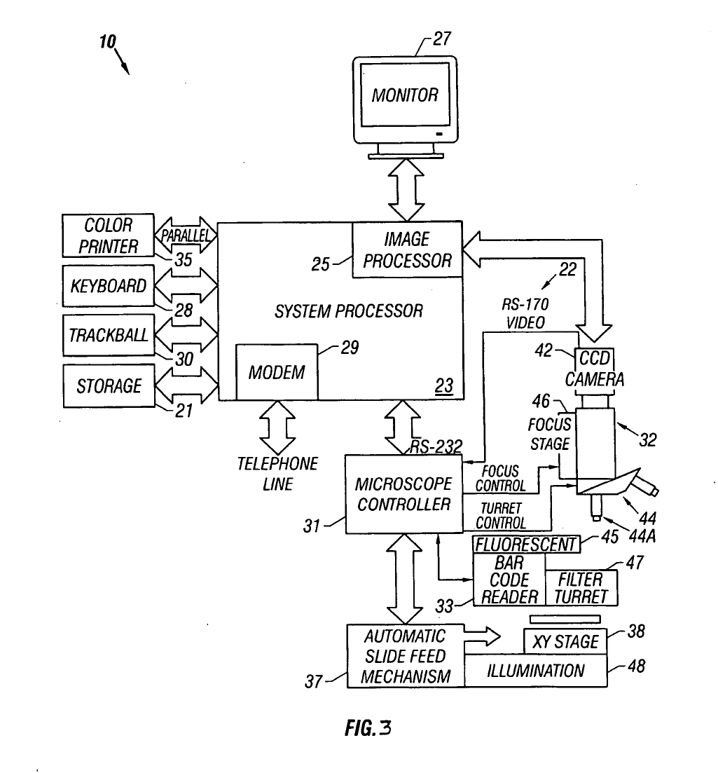

Referring now to FIGS. 2 and 3, an apparatus for automated cell analysis of biological samples is generally indicated by reference numeral 10 as shown in perspective view in FIG. 2 and in block diagram form in FIG. 3. The apparatus 10 comprises a microscope subsystem 32 housed in a housing 12. The housing 12 includes a slide carrier input hopper 16 and a slide carrier output hopper 18. A door 14 in the housing 12 secures the microscope subsystem from the external environment. A data processing subsystem can comprise a computer 22 having at least one system processor 23, and a communications modem 29. The computer subsystem further includes a computer/image monitor 27 and other external peripherals including storage device 21, a pointing device, such as a track ball or mouse device 30, a user input device, such as a touch screen, keyboard, or voice recognition unit 28 and color printer 35. An external power supply 24 is also shown for power outage protection. The apparatus 10 further includes an optical sensing array 42, such as, for example, a CCD camera, for acquiring images. Microscope movements are under the control of system processor 23 through a number of microscope-subsystem functions described further in detail herein. An automatic slide feed mechanism in conjunction with X-Y stage 38 provide automatic slide handling in the apparatus 10. An illumination 48 comprising a bright field transmitted light source projects light onto a sample on the X-Y stage 38, which is subsequently imaged through the microscope subsystem 32 and acquired through optical sensing array 42 for processing by the system processor 23. A Z stage or focus stage 46 under control of the system processor 23 provides displacement of the microscope subsystem in the Z plane for focusing. The microscope subsystem 32 further includes a motorized objective turret 44 for selection of objectives.

The apparatus 10 may further include a fluorescent excitation light source 45 and may further include a plurality of fluorescent filters on a turret or wheel 47. Alternatively, a filter wheel may have an electronically tunable filter. In one aspect, fluorescent excitation light from fluorescent excitation light source 45 passes through fluorescent filter 47 and proceeds to contact a sample on the XY stage 38. Fluorescent emission light emitted from a fluorescent reagent contained on a sample passes through objective 44a to optical sensing array 42. The fluorescent emission light forms an image, which is digitized by an optical sensing array 42, and the digitized image is sent to an image processor 25 for subsequent processing. The image processor 25 may be an integral part of a system processor or a separate and distinct processor unit.

The purpose of the apparatus 10 is for the automatic scanning of prepared microscope slides for the detection of candidate objects of interest such as normal and abnormal cells, e.g., tumor cells, endothelial cells, endothelial progenitor cells and/or apoptotic fragments thereof. In one aspect, the apparatus 10 is capable of detecting rare events, e.g., event in which there may be only one candidate object of interest per several hundred thousand objects, e.g., one to five candidate objects of interest per 2 square centimeter area of the slide. The apparatus 10 automatically locates and can count candidate objects of interest noting the coordinates or location of the candidate object of interest on a slide based upon color, size and shape characteristics. A number of stains and reagents can be used to stain candidate objects of interest and other objects (e.g., normal cells, cell fragments and the like) different colors so that such cells can be distinguished from each other.

A biological sample may be prepared with a reagent to obtain a colored insoluble precipitate. An apparatus 10 can be used to detect this precipitate as a candidate object of interest. During operation of the apparatus 10, a pathologist or laboratory technician mounts slides onto slide carriers. Each slide may contain a single sample or a plurality of samples (e.g., a microarray). A slide carrier 60 may be used to hold a plurality of slides. Each slide carrier can be designed to hold a number of slides from about 1-50 or more. A number of slide carriers are then loaded into input hopper 16 (see FIG. 3). The operator can specify the size, shape and location of the area to be scanned or alternatively, the system can automatically locate an area. The operator then commands the system to begin automated scanning of the slides through a graphical user interface. Unattended scanning begins with the automatic loading of the first carrier and slide onto the precision motorized X-Y stage 38. In one aspect of the invention, a bar code label affixed to the slide or slide carrier is read by a bar code reader 33 during this loading operation. Each slide is then scanned a desired magnification, for example, 10×, to identify candidate cells or objects of interest based on their color, size and shape characteristics. The term “coordinate” or “address” is used to mean a particular location on a slide or sample. The coordinate or address can be identified by any number of means including, for example, X-Y coordinates, r-θ coordinates, polar, vector or other coordinate systems known in the art. In one aspect of the invention a slide is scanned under a first parameter comprising a desired magnification and using a bright field light source from illumination 48 (see FIG. 3) to identify a candidate cell or object of interest.

In some implementations, the methods, systems, and apparatus can obtain a low magnification image of a candidate cell or object of interest and then return to each candidate cell or object of interest based upon the previously stored coordinates to reimage and refocus at a higher magnification such as 40× or to reimage under fluorescent conditions. To avoid missing candidate cells or objects of interest, the system can process low magnification images by reconstructing the image from individual fields of view and then determine objects of interest. In this manner, objects of interest that overlap more than one objective field of view may be identified. A storage device 21 can be used to store an image of a candidate cell or object of interest for later review by a pathologist or to store identified coordinates for later use in processing the sample or a subsample. The storage device 21 can be a removable hard drive, DAT tape, local hard drive, optical disk, or may be an external storage system whereby the data is transmitted to a remote site for review or storage. In one aspect, stored images (from both fluorescent and bright field light) can be overlapped and viewed in a mosaic of images for further review.

Apparatus 10 may also be used for fluorescent imaging (e.g., in FISH techniques) of prepared microscope slides for the detection of candidate objects of interest such as normal and abnormal cells, e.g., tumor cells. The apparatus 10 automatically locates the coordinates of previously identified candidate cells or objects of interest based upon the techniques described above. In this aspect, the slide has been contacted with-a fluorescent reagent labeled with a fluorescent indicator. The fluorescent reagent is an antibody, polypeptide, oligonucleotide, or polynucleotide labeled with a fluorescent indicator. A number of fluorescent indicators are known in the art and include DAPI, Cy3, Cy3.5, Cy5, CyS.5, Cy7, umbelliferone, fluorescein, fluorescein isothiocyanate (FITC), rhodamine, dichlorotriazinylamine fluorescein, dansyl chloride or phycoerythrin. In another aspect, a luminescent material may be used. Useful luminescent materials include luminol; examples of bioluminescent materials include luciferase, luciferin, and aequorin.

A fluorescent indicator should have distinguishable excitation and emission spectra. Where two or more fluorescent indicators are used they should have differing excitation and emission spectra that differ, respectively, by some minimal value (typically about 15-30 nm). The degree of difference will typically be determined by the types of filters being used in the process. Typical excitation and emission spectra for DAPI, FITC, Cy3, Cy3.5, Cy5, CyS.5, and Cy7 are provided below:

| Fluorescent indicator | Excitation Peak | Emission Peak |
|---|---|---|
| DAPI | 350 | 450 |
| FITC | 490 | 520 |
| Cy3 | 550 | 570 |
| Cy3.5 | 580 | 595 |
| Cy5 | 650 | 670 |
| Cy5.5 | 680 | 700 |
| Cy7 | 755 | 780 |

The automated microscope system scans a biological sample contacted with a fluorescent reagent under conditions such that a fluorescent indicator attached to the reagent fluoresces, or scans a biological sample labeled with a luminescent reagent under conditions that detects light emissions from a luminescent indicator. Examples of conditions include providing a fluorescent excitation light that contacts and excites the fluorescent indicator to fluoresce. In one aspect, a bar code label affixed to a slide or slide carrier is read by a bar code reader 33 during a loading operation. The bar code provides the system with information including, for example, information about the scanning parameters including the type of light source or the excitation light wavelength to use. The bar code can be a linear read bar code or a 2D bar code or a code read by an OCR (optical character recognition) device.

The methods, system, and apparatus in some implementations of the invention can obtain a first image using a transmitted and/or reflected light source at either a low magnification or high magnification of a candidate cell or object of interest and then return to the coordinates (or corrected coordinates) associated with each candidate cell or object of interest in the same sample or a related subsample to obtain an additional images at a higher magnification or additional images using a different imaging technique (e.g., fluorescent images). Images can be stored on a storage device 21 for later review by a pathologist. In one aspect, stored images (from both fluorescent and bright field light) can be overlapped and/or viewed in a mosaic of images for further review.

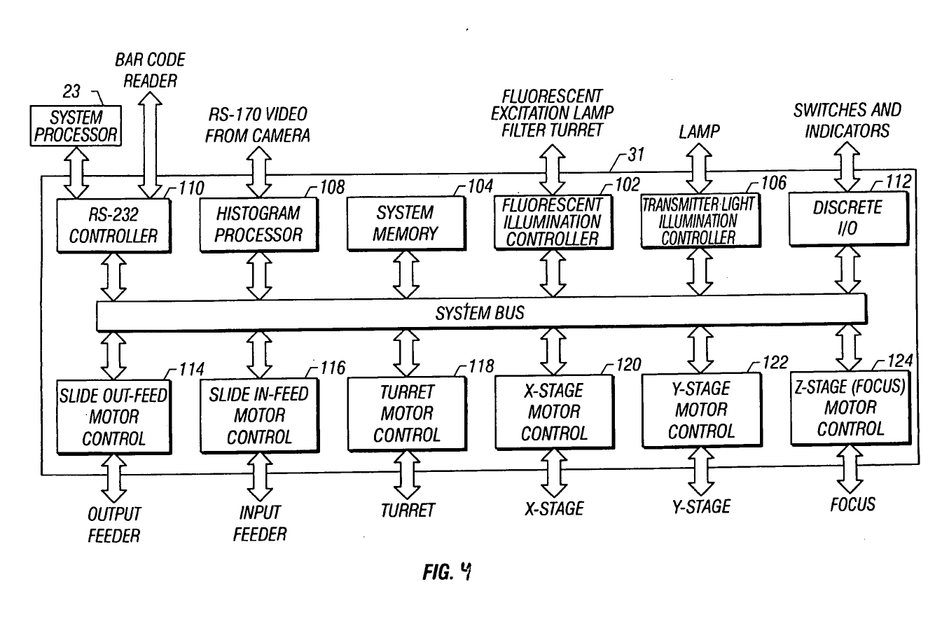

Having described the overall operation of the apparatus 10 from a high level, the further details of the apparatus will now be described. Referring to FIG. 4, the microscope controller 31 is shown in more detail. The microscope controller 31 includes a number of subsystems. The apparatus system processor 23 controls these subsystems. The system processor 23 controls a set of motor—control subsystems 114 through 124, which control the input and output feeder, the motorized turret 44, the X-Y stage 38, and the Z stage 46 (FIG. 3). The system processor 23 further controls a transmitted light illumination controller 106 for control of substage illumination 48 bright field transmitted light source and controls a fluorescent excitation illumination controller 102 for control of fluorescent excitation light source 45 and/or filter turret 47. The transmitted light illumination controller 106 is used in conjunction with camera and image collection adjustments to compensate for the variations in light level in various samples. The light control software samples the output from the camera at intervals (such as between loading of slide carriers), and commands the transmitted light illumination controller 106 to adjust the light or image collection functions to the desired levels. In this way, light control is automatic and transparent to the user and adds no additional time to system operation. Similarly, fluorescent excitation illumination controller 102 is used in conjunction with the camera and image collection adjustments to compensate for the variations in fluorescence in various samples. The light control software samples the output from the camera at intervals (such as between loading of slide carriers and may include sampling during image collection), and commands the fluorescent excitation illumination controller 102 to adjust the fluorescent excitation light or image exposure time to a desired level. In addition, the fluorescent excitation illumination controller 102 may control the filter wheel or wavelength 47. The system processor 23 can be a high performance data processor of at least 200 MHz, for example, the system processor may comprise dual parallel, Intel, 1 GHZ devices. Advances in data processors are being routinely made in the computer industry. Accordingly, the claims should not be limited by the type of data processor or speed of the data processor disclosed herein.

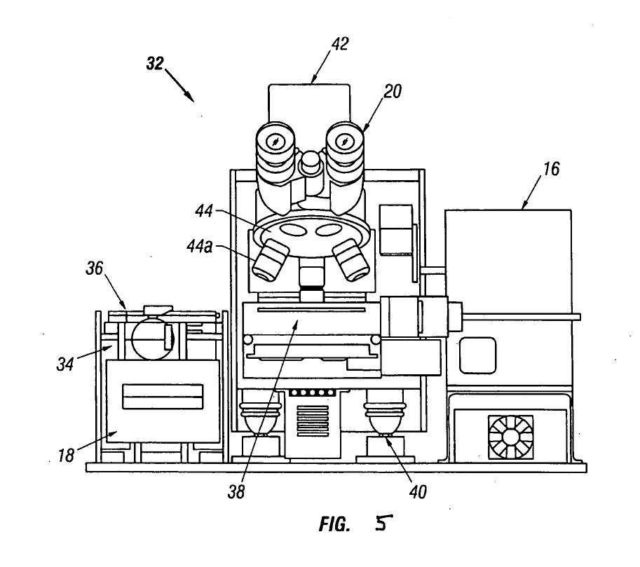

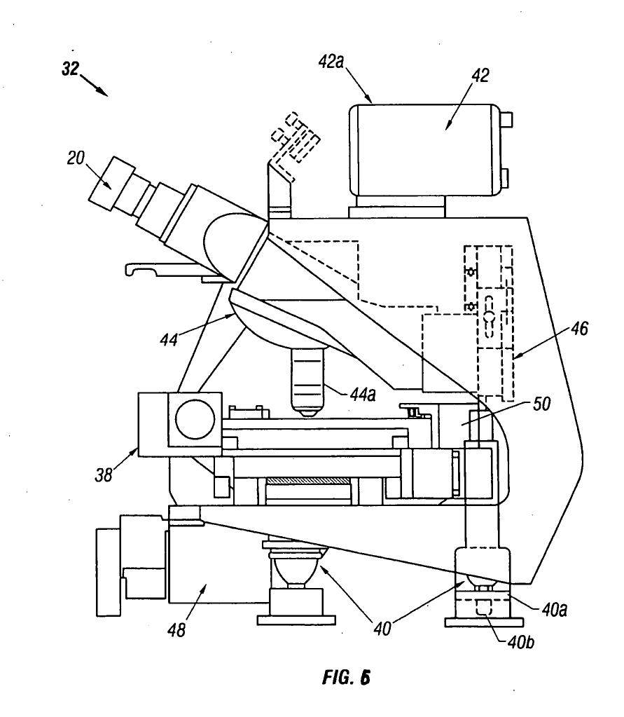

Referring now to FIGS. 5 and 6, further detail of the apparatus 10 is shown. FIG. 5 shows a plan view of the apparatus 10 with the housing 12 removed. Shown is slide carrier unloading assembly 34 and unloading platform 36 which in conjunction with slide carrier output hopper 18 function to receive slide carriers which have been analyzed. Vibration isolation mounts 40, shown in further detail in FIG. 6, are provided to isolate the microscope subsystem 32 from mechanical shock and vibration that can occur in a typical laboratory environment. In addition to external sources of vibration, the high-speed operation of the X-Y stage 38 can induce vibration into the microscope subsystem 32. Such sources of vibration can be isolated from the electro-optical subsystems to avoid any undesirable effects on image quality. The isolation mounts 40 comprise a spring 40a and piston 40b (see FIG. 6) submerged in a high viscosity silicon gel which is enclosed in an elastomer membrane bonded to a casing to achieve damping factors on the order of about 17 to 20%. Other dampening devices are known in the art and may be substituted or combined with the dampening device provided herein. Occulars 20 are shown in FIGS. 5 and 6, however, their presence is an optional feature. The occulars 20 may be absent without departing from the advantages or functionality of the system.

Having described the overall system and the automated slide handling feature, the aspects of the apparatus 10 relating to scanning, focusing and image processing will now be described in further detail.

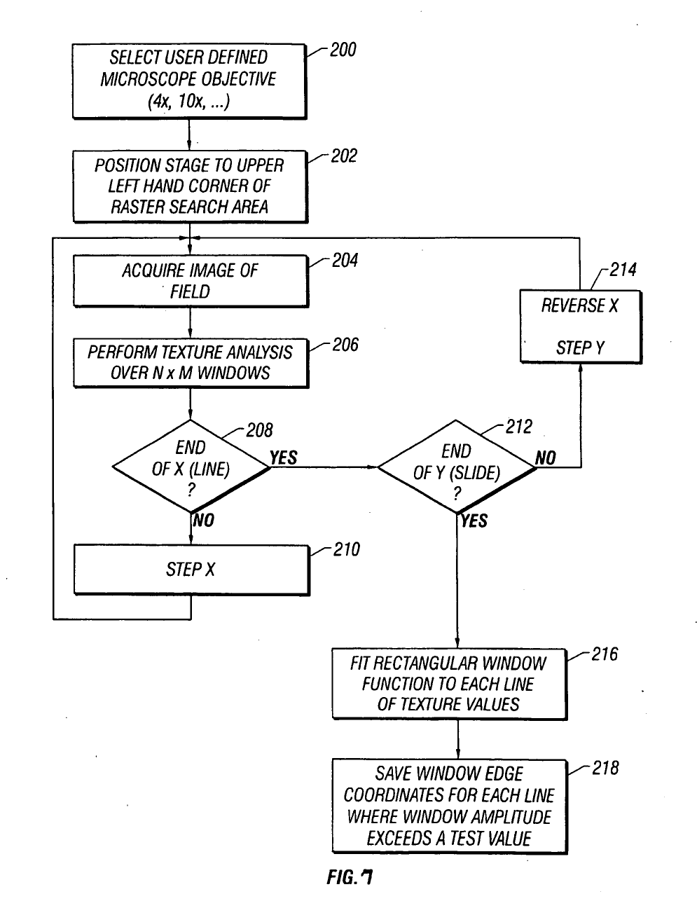

In some cases, an operator will know ahead of time where the scan area of interest is on a slide comprising a sample. Conventional preparation of slides for examination provides repeatable and known placement of the sample on the slide. The operator can therefore instruct the system to always scan the same area at the same location of every slide, which is prepared in this fashion. But there are other times in which the area of interest is not known, for example, where slides are prepared manually with a smear technique. In one implementation, the scan area can be automatically determined using a texture or density analysis process. FIG. 7 is a flow diagram that describes the processing associated with the automatic location of a scan area. As shown in this flow diagram, a basic method is to pre-scan the entire slide area (or image the entire slide sample area at a low magnification) under transmitted and/or reflected light to determine texture features that indicate the presence of a smear or tissue and to discriminate these areas from dirt and other artifacts. In addition, one or more distinctive features may be identified and the coordinates determined in order to make corrections to identify objects of interest in a serial subsample as described herein and using techniques known in the art.

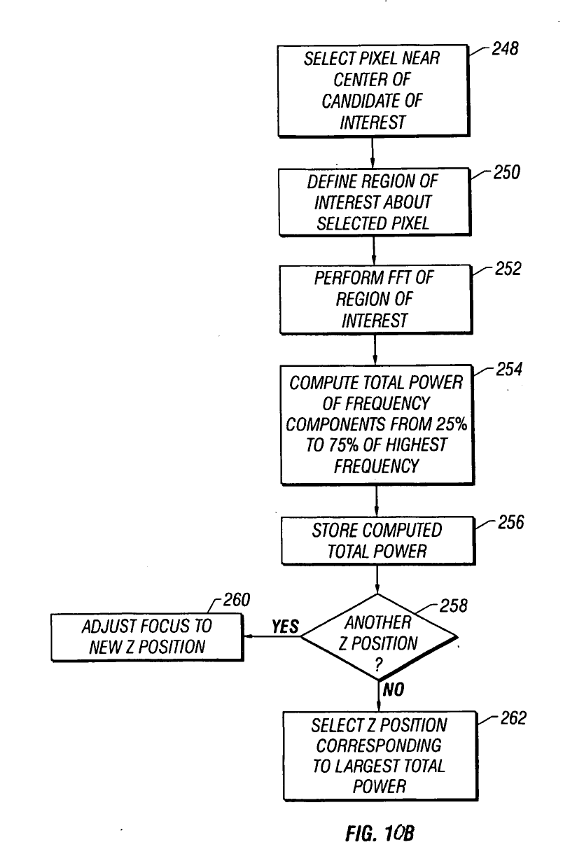

As a first step the system determines whether a user defined microscope objective has been identified 200. The system then sets the stage comprising the sample to be scanned at a predetermined position, such as the upper left hand corner of a raster search area 202. At each location of a raster scan, an image such as in FIG. 10 is acquired 204 and analyzed for texture/border information 206. Since it is desired to locate the edges of the smear or tissue sample within a given image, texture analyses are conducted over areas called windows 78 (FIG. 10), which are smaller than the entire image as shown in FIG. 10. The process iterates the scan across the slide at steps 208, 210, 212, and 214.

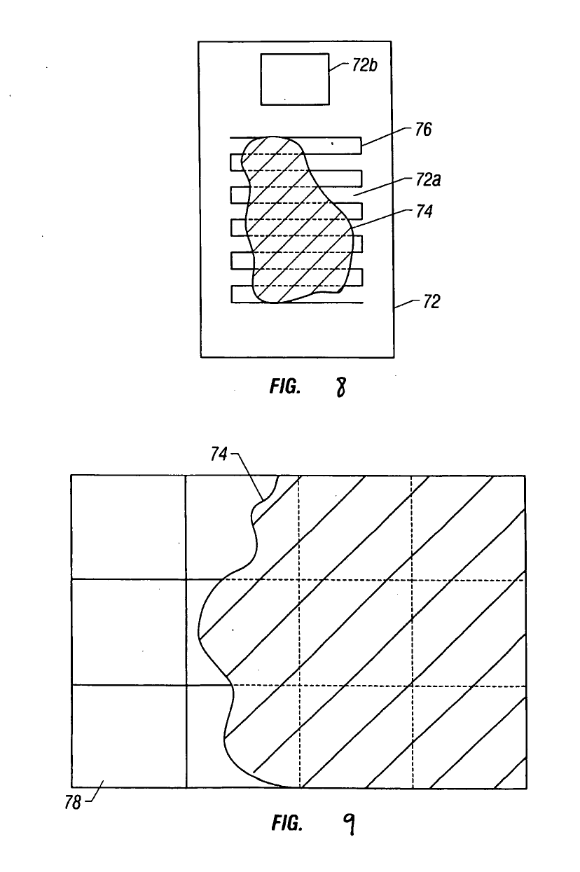

The texture analysis process can be performed at a lower magnification, such as at a 4× objective, for a rapid analysis. One reason to operate at low magnification is to image the largest slide area at any one time. Since cells do not yet need to be resolved at this stage of the overall image analysis, the 4× magnification works well. Alternatively, a higher magnification scan can be performed, which may take additional time due to the field of view being smaller and requiring additional images to be processed. On a typical slide, as shown in FIG. 8, a portion 72b of the end of the slide 72 is reserved for labeling with identification information. Excepting this label area, the entire slide is scanned in a raster scan fashion to yield a number of adjacent images. Texture values for each window include the pixel variance over a window, the difference between the largest and smallest pixel value within a window, and other indicators. The presence of a smear or tissue raises the texture values compared with a blank area.

One problem with a smear or tissue, from the standpoint of determining its location, is its non-uniform thickness and texture. For example, the smear or tissue or sample is likely to be relatively thin at the edges and thicker towards the middle due to the nature of the smearing process. To accommodate this non-uniformity, texture analysis provides a texture value for each analyzed area. The texture value tends to gradually rise as the scan proceeds across a smear tissue from a thin area to a thick area, reaches a peak, and then falls off again to a lower value as a thin area at the edge is reached. The problem is then to decide from the series of texture values the beginning and ending, or the edges, of the smear or tissue. The texture values are fit to a square wave waveform since the texture data does not have sharp beginnings and endings.

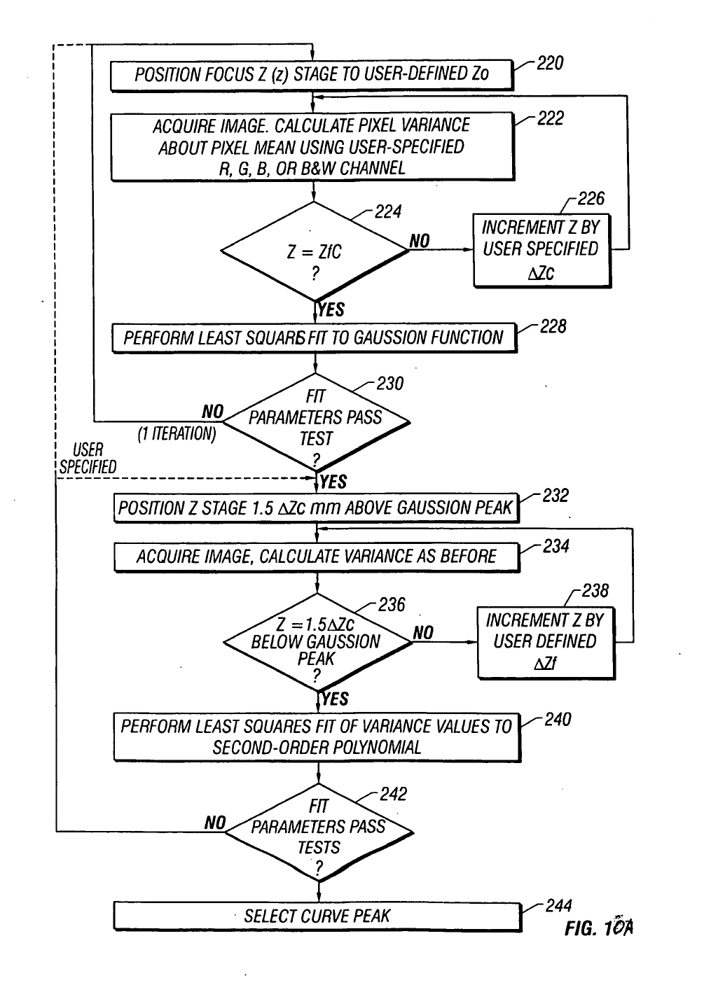

After conducting this scanning and texture evaluation operation, one can determine which areas of elevated texture values represent the desired smear or tissue 74 (see FIG. 9), and which represent undesired artifacts. This can be accomplished by fitting a step function, on a line-by-line basis, to the texture values in step 216 (see FIG. 7). This function, which resembles a single square wave beginning at one edge and ending at the other edge and having an amplitude, provides the means for discrimination. The amplitude of the best-fit step function is utilized to determine whether smear (tissue) or dirt is present since relatively high values indicate smear (tissue). If it is decided that smear (tissue) is present, the beginning and ending coordinates of this pattern are noted until all lines have been processed, and the smear (tissue) sample area defined at 218.

The first-past scan above can be used to determine a particular orientation of a sample. For example, digital images are,comprised of a series of pixels arranged in a matrix, a grayscale value is can be attributed to each pixel to indicate the appearance thereof of the image. “Orientation matching” between two samples (e.g., two serial sections stained with different reagents) is then performed by comparing these grayscale values relative to their positions in both the first sample image (i.e., the template) and the second sample image. A match is found when the same or similar pattern is found in the second image when compared to the first image. Such systems are typically implemented in a computer or other data processing device for use in various manufacturing and robotic applications and are applicable to the methods and systems described herein. For example, such systems have been utilized to automate tasks such as semiconductor wafer handling operations, fiducial recognition for pick-and-place printed circuit board (PCB) assembly, machine vision for quantification or system control to assist in location of objects on conveyor belts, pallets, and trays, and automated recognition of printed matter to be inspected, such as alignment marks. The matrix of pixels used to represent such digital images are typically arranged in a Cartesian coordinate system or other arrangement of non-rectangular pixels, such as hexagonal or diamond shaped pixels. Recognition methods usually require scanning the search image scene pixel by pixel in comparison with the template, which is sought. Further, known search techniques allow for transformations such as rotation and scaling of the template image within the second sample image, therefore requiring the recognition method to accommodate for such transformations.

Normalized grayscale correlation (NGC) has been used to match digital images reliably and accurately, as is disclosed in U.S. Pat. No. 5,602,937, entitled “Methods and Apparatus for Machine Vision High Accuracy Searching,” assigned to Cognex Corporation. In addition, such software is available commercially through the Matrox Imaging Library version 7.5 (Matrox Electronic Systems Ltd., Canada).

After an initial focusing operation described further herein, the scan area of interest is scanned to acquire images for image analysis. In one aspect, a bar code or computer-readable label placed at 72b (see FIG. 8) comprises instructions regarding the processing parameters of a particular slide as well as additional information such as a subject's name/initials or other identification. Depending upon the type of scan to be performed (e.g., fluorescence, transmitted, and/or reflected light) a complete scan of the slide at low magnification is made to identify and locate candidate objects of interest, followed by further image analysis of the candidate objects of interest at high magnification in order to confirm the candidate cells or objects of interest. An alternate method of operation is to perform high magnification image analysis of each candidate object of interest immediately after the object has been identified at low magnification. The low magnification scanning then resumes, searching for additional candidate objects of interest. Since it takes on the order of a few seconds to change objectives, this alternate method of operation would take longer to complete.

To identify structure in tissue that cannot be captured in a single field of view image or a single staining/labeling technique, the invention can provide a method for histological reconstruction to analyze many fields of view on potentially many slides simultaneously. The method couples composite images in an automated manner for processing and analysis. A slide on which is mounted a cellular specimen stained to identify objects of interest is supported on a motorized stage. An image of the cellular specimen is generated, digitized, and stored in memory. As the viewing field of the objective lens is smaller than the entire cellular specimen, a histological reconstruction is made. These stored images of the entire tissue section may then be placed together in an order such that the H/E stained slide is paired with the immunohistochemistry slide, which in turn may be paired with a fluorescently labeled slide so that analysis of the images may be performed simultaneously.

An overall detection process for a candidate cell or object of interest includes a combination of decisions made at both a low (e.g., 4× or 10×) and a high magnification (40×) level. Decision-making at the low magnification level is broader in scope, e.g., objects that loosely fit the relevant color, size, and shape characteristics are identified at a 10× level.

Analysis at the 40× magnification level, then proceeds to refine the decision-making and confirm objects as likely cells or candidate objects of interest. For example, at the 40× level it is not uncommon to find that some objects that were identified at lox are artifacts, which the analysis process will then reject. In addition, closely packed objects of interest appearing at lox are separated at the 40× level. In a situation where a cell straddles or overlaps adjacent image fields, image analysis of the individual adjacent image fields could result in the cell being rejected or undetected. To avoid missing such cells, the scanning operation compensates by overlapping adjacent image fields in both the x and y directions. An overlap amount greater than half the diameter of an average cell is desirable. In one implementation, the overlap is specified as a percentage of the image field in the x and y directions. Alternatively, a reconstruction method as described herein may be used to reconstruct the image from multiple fields of view. The reconstructed image is then analyzed and processed to find objects of interest.

The time to complete an image analysis can vary depending upon the size of the scan area and the number of candidate cells or objects of interest identified. For example, in one implementation, a complete image analysis of a scan area of two square centimeters in which 50 objects of interest are confirmed can be performed in about 12 to 15 minutes. This example includes not only focusing, scanning and image analysis but also the saving of 40× images as a mosaic on storage device 21 (FIG. 3).

However the scan area is defined, an initial focusing operation should be performed on each slide prior to scanning. This is required since slides differ, in general, in their placement in a carrier. These differences include slight variations of tilt of the slide in its carrier. Since each slide must generally remain in focus during scanning, the degree of tilt of each slide must generally be determined. This is accomplished with an initial focusing operation that determines the exact degree of tilt, so that focus can be maintained automatically during scanning.

The methods may vary from simple to more complex methods involving IR beam reflection and mechanical gauges. The initial focusing operation and other focusing operations to be described later utilize a focusing method based on processing of images acquired by the system. This method results in lower system cost and improved reliability since no additional parts need be included to perform focusing. FIG. 10A provides a flow diagram describing the “focus point” procedure. The basic method relies on the fact that the pixel value variance (or standard deviation) taken about the pixel value mean is maximum at best focus. A “brute-force” method could simply step through focus, using the computer controlled Z, or focus stage, calculate the pixel variance at each step, and return to the focus position providing the maximum variance. Such a method is time consuming. One method includes the determination of pixel variance at a relatively coarse number of focal positions, and then the fitting a curve to the data to provide a faster means of determining optimal focus. This basic process is applied in two steps, coarse and fine.

With reference to FIG. 10A-B, during the coarse step at 220-230, the Z stage is stepped over a user-specified range of focus positions, with step sizes that are also user-specified. It has been found that for coarse focusing, these data are a close fit to a Gaussian function. Therefore, this initial set of variance versus focus position data are least-squares fit to a Gaussian function at 228. The location of the peak of this Gaussian curve determines the initial or coarse estimate of focus position for input to step 232.

Following this, a second stepping operation 232-242 is performed utilizing smaller steps over a smaller focus range centered on the coarse focus position. Experience indicates that data taken over this smaller range are generally best fit by a second order polynomial. Once this least squares fit is performed at 240, the peak of the second order curve provides the fine focus position at 244.

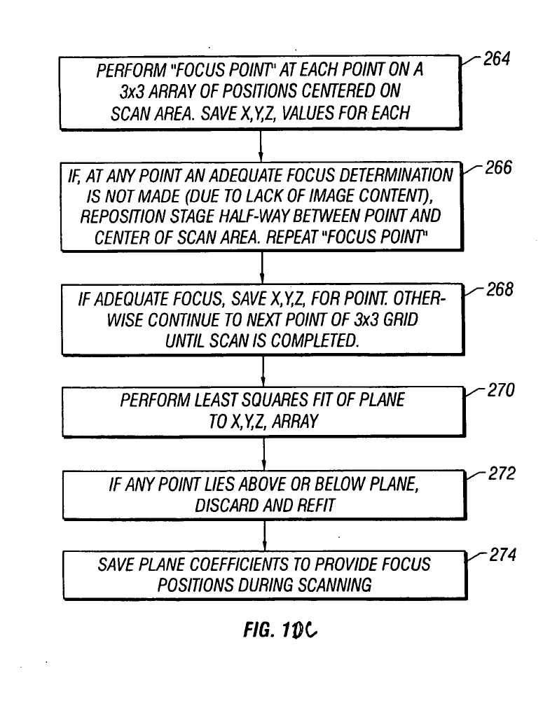

FIG. 10C illustrates a procedure for how this focusing method is utilized to determine the orientation of a slide in its carrier. As shown, focus positions are determined, as described above, for a 3×3 grid of points centered on the scan area at 264. Should one or more of these points lie outside the scan area, the method senses this at 266 by virtue of low values of pixel variance. In this case, additional points are selected closer to the center of the scan area. FIG. 11 shows the initial array of points 80 and new point 82 selected closer to the center. Once this array of focus positions is determined at 268, a least squares plane is fit to this data at 270. Focus points lying too far above or below this best-fit plane are discarded at 272 (such as can occur from a dirty cover glass over the scan area), and the data is then refit. This plane at 274 then provides the desired Z position information for maintaining focus during scanning.

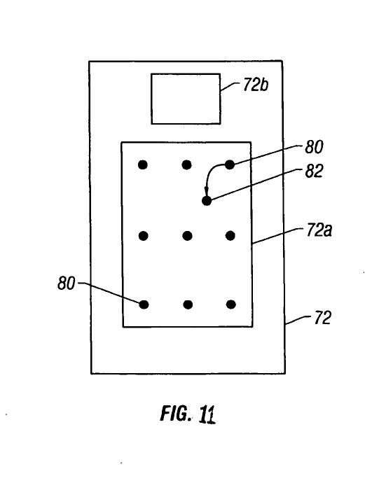

After determination of the best-fit focus plane, the scan area is scanned in an X raster scan over the scan area as described earlier. During scanning, the X stage is positioned to the starting point of the scan area, the focus (Z) stage is positioned to the best fit focus plane, an image is acquired and processed, and this process is repeated for all points over the scan area. In this way, focus is maintained automatically without the need for time-consuming refocusing at points during scanning. Prior to confirmation of candidate cells or objects of interest at a 40× or 60× level, a refocusing operation can be conducted since the use of this higher magnification may require more precise focus than the best-fit plane provides. FIG. 12 provides the flow diagram for this process. As may be seen, this process is similar to the fine focus method described earlier in that the object is to maximize the image pixel variance. This is accomplished by stepping through a range of focus positions with the Z stage at 276 and 278, calculating the image variance at each position at 278, fitting a second order polynomial to these data at 282, and calculating the peak of this curve to yield an estimate of the best focus position at 284 and 286. This final focusing step differs from previous ones in that the focus range and focus step sizes are smaller since this magnification requires focus settings to within 0.5 micron or better. It should be noted that for some combinations of cell staining characteristics, improved focus can be obtained by numerically selecting the focus position that provides the largest variance, as opposed to selecting the peak of the polynomial. In such cases, the polynomial is used to provide an estimate of best focus, and a final step selects the actual Z position giving highest pixel variance. It should also be noted that if at any time during the focusing process at 40× or 60× the parameters indicate that the focus position is inadequate, the system automatically reverts to a coarse focusing process as described above with reference to FIG. 10. This ensures that variations in specimen thickness can be accommodated in an expeditious manner. For example, certain white blood cells known as neutrophils can be stained with Fast Red, a commonly known stain, to identify alkaline phosphatase in the cytoplasm of the cells. To further identify these cells and the material within them, the specimen can be counterstained with hematoxylin to identify the nucleus of the cells. In cells so treated, the cytoplasm bearing alkaline phosphatase becomes a shade of red proportionate to the amount of alkaline phosphatase in the cytoplasm and the nucleus becomes blue. However, where the cytoplasm and nucleus overlap, the cell appears purple. These color combinations can preclude the finding of a focused Z position using the focus processes discussed above. Where a sample has been labeled with a fluorescent reagent, the focus plane can be based upon the intensity of a fluorescent signal. For example, as the image scans through a Z-plane of the sample, the intensity of fluorescence will change as the focus plane passes closer to the fluorescence indicator.

In an effort to find a best focal position at high magnification, a focus method, such as the one shown in FIG. 10B, can be used. That method begins by selecting a pixel near the center of a candidate object of interest 248 and defining a region of interest centered about the selected pixel 250. Typically, the width of the region of interest is a number of columns, which is a power of 2. This width determination arises from subsequent processing of the region of interest using a one dimensional Fast Fourier Transform (FFT) technique. As is well known in the art, processing columns of pixel values using the FFT technique is facilitated by making the number of columns to be processed a power of two. While the height of the region of interest is also a power of two, it need not be unless a two dimensional FFT technique is used to process the region of interest.

After the region of interest is selected, the columns of pixel values are processed using a one dimensional FFT to determine a spectra of frequency components for the region of interest 252. The frequency spectra ranges from DC to some highest frequency component. For each frequency component, a complex-magnitude is computed. The complex magnitudes for the frequency components, which range from approximately 25% of the highest component to approximately 75% of the highest component, are squared and summed to determine the total power for the region of interest 254. Alternatively, the region of interest can be processed with a smoothing window, such as a Hanning window, to reduce the spurious high frequency components generated by the FFT processing of the pixel values in the region of interest. Such preprocessing of the region of interest permits complex magnitudes over the complete frequency range to be squared and summed. After the power for a region has been computed and stored 256, a new focal position is selected, focus adjusted 258 and 260, and the process repeated. After each focal position has been evaluated, the one having the greatest power factor is selected as the one best in focus 262.

The following describes the image processing methods which are utilized to decide whether a candidate object of interest such as a stained endothelial-type cell is present in a given image, or field, during the imaging process. Candidate objects of interest, which are detected during scanning, can be reimaged at higher (40× or 60×) magnification, the decision confirmed, and an image of the object of interest as well as its coordinates saved for later review. In one implementation, objects of interest are first acquired and identified under transmitted and/or reflected light. The image processing includes color space conversion, low pass filtering, background suppression, artifact suppression, morphological processing, and blob analysis. One or more of these steps can optionally be eliminated. The operator can optionally configure the system to perform any or all of these steps and whether to perform certain steps more than once or several times in a row. It should also be noted that the sequence of steps can be varied and thereby optimized for specific reagents or reagent combinations; however, a typical sequence is described herein.

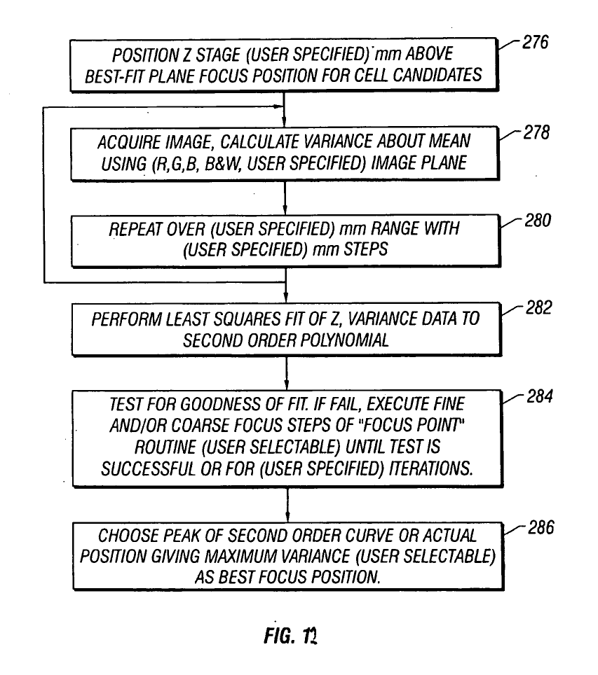

An overview of the identification process is shown in FIG. 13. The process for identifying and locating candidate objects of interest in a stained biological sample on a slide begins with an acquisition of images obtained by scanning the slide or imaging the whole slide at low magnification 288. Each image is then converted from a first color space to a second color space 290 and the color converted image is low pass filtered 292. The pixels of the low pass filtered image are then compared to a threshold 294 and those pixels having a value equal to or greater than the threshold are identified as candidate object of interest pixels and those less than the threshold are determined to be artifact or background pixels. The candidate object of interest pixels are then morphologically processed to identify groups of candidate object of interest pixels as candidate objects of interest 296. These candidate objects of interest are then compared to blob analysis parameters 298 to further differentiate candidate objects of interest from objects, which do not conform to the blob analysis parameters and do not warrant further processing. The location of the candidate objects of interest can be stored prior to confirmation at high magnification. The process continues by determining whether the candidate objects of interest have been confirmed 300. If they have not been confirmed, the optical system is set to high magnification 302 and images of the slide at the locations corresponding to the candidate objects of interest identified in the low magnification images are acquired 288. These images are then color converted 290, low pass filtered 292, compared to a threshold 294, morphologically processed 296, and compared to blob analysis parameters 298 to confirm which candidate objects of interest located from the low magnification images are objects of interest. The coordinates of the objects of interest are then stored for future reference.

In general, the candidate objects of interest, such as tumor cells, are detected based on a combination of characteristics, including size, shape, and color. The chain of decision making based on these characteristics begins with a color space conversion process. The optical sensing array coupled to the microscope subsystem outputs a color image comprising a matrix of pixels. Each pixel comprises red, green, and blue (RGB) signal values.

It is desirable to transform the matrix of RGB values to a different color space because the difference between candidate objects of interest and their background, such as endothelial cell-types, can be determined from their respective colors. Samples are generally stained with one or more standard stains (e.g., DAB, New Fuchsin, AEC), which are “reddish” in color. Candidate objects of interest retain more of the stain and thus appear red while normal cells remain unstained. The specimens can also be counterstained with hematoxylin so the nuclei of normal cells or cells not containing an object of interest appear blue. In addition to these objects, dirt and debris can appear as black, gray, or can also be lightly stained red or blue depending on the staining procedures utilized. The residual plasma or other fluids also present on a smear (tissue) can also possess some color.

In the color conversion operation, a ratio of two of the RGB signal values is formed to provide a means for discriminating color information. With three signal values for each pixel, nine different ratios can be formed: R/R, R/G, R/B, G/G, G/B, G/R, B/B, B/G, B/R. The optimal ratio to select depends upon the range of color information expected in the slide sample. As noted above, typical stains used in light microscopy for detecting candidate objects of interest such as tumor cells are predominantly red, as opposed to predominantly green or blue. Thus, the pixels of an object of interest that has been stained would contain a red component, which is larger than either the green or blue components. A ratio of red divided by blue (R/B) provides a value which is greater than one for, e.g. tumor cells, but is approximately one for any clear or white areas on the slide. Since other components of the sample, for example, normal cells, typically are stained blue, the R/B ratio for pixels of these other components (e.g., normal cells) yields values of less than one. The R/B ratio is used for separating the color information typical in these applications.

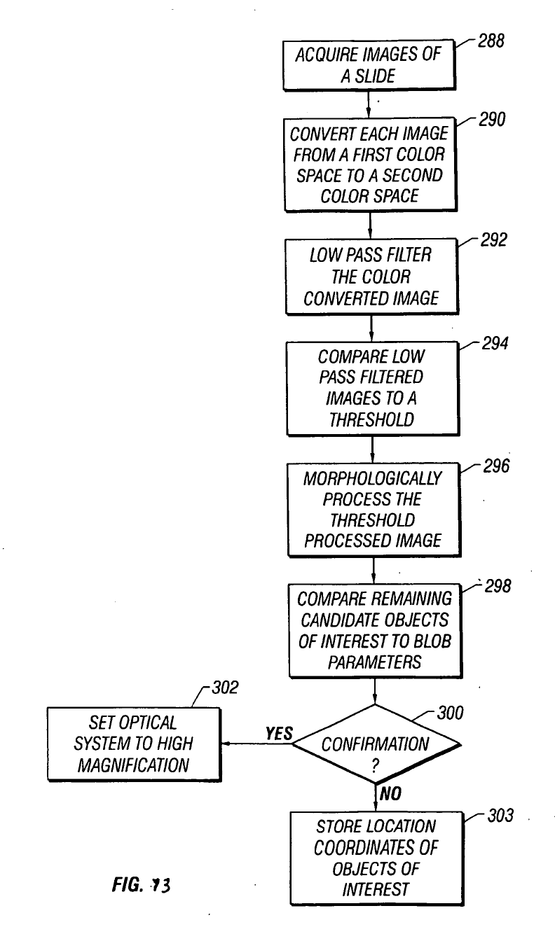

FIG. 14 illustrates the flow diagram by which this conversion is performed. In the interest of processing speed, a conversion can be implemented with a look up table. The use of a look up table for color conversion accomplishes three functions: 1) performing a division operation; 2) scaling the result for processing as an image having pixel values ranging from 0 to 255; and 3) defining objects which have low pixel values in each color band (R,G,B) as “black” to avoid infinite ratios (e.g., dividing by zero). These “black” objects are typically staining artifacts or can be edges of bubbles caused by pasting a coverglass over the specimen. Once the look up table is built at 304 for the specific color ratio (e.g., choices of epithelial cell stains), each pixel in the original RGB image is converted at 308 to produce the output. Since it is of interest to separate the red stained tumor cells from blue stained normal ones, the ratio of color values is then scaled by a user specified factor. As an example, for a factor of 128 and the ratio of (red pixel value)/(blue pixel value), clear areas on the slide would have a ratio of 1 scaled by 128 for a final X value of 128. Pixels that lie in red stained tumor cells would have X value greater than 128, while blue stained nuclei of normal cells would have value less than 128. In this way, the desired objects of interest can be numerically discriminated. The resulting pixel matrix, referred to as the X-image, is a gray scale image having values ranging from 0 to 255.

Other methods exist for discriminating color information. One classical method converts the RGB color information into another color space, such as HSI (hue, saturation, intensity) space. In such a space, distinctly different hues such as red, blue, green, yellow, can be readily separated. In addition, relatively lightly stained objects can be distinguished from more intensely stained ones by virtue of differing saturations. Methods of converting from RGB space to HSI space are described in U.S. Pat. No. 6,404,916 B1, the entire contents of which are incorporated by reference. In brief, color signal inputs are received by a converter that converts the representation of a pixel's color from red, green, and blue (RGB) signals to hue, saturation, and intensity signals (HSI). The conversion of RGB signals to HSI signals is equivalent to a transformation from the rectilinear RGB coordinate system used in color space to a cylindrical coordinate system in which hue is the polar coordinate, saturation is the radial coordinate, and intensity is the axial coordinate, whose axis lies on a line between black and white in coordinate space. A number of algorithms to perform this conversion are known, and computer chips are available to perform the algorithms.

Exemplary methods include a process whereby a signal representative of a pixel color value is converted to a plurality of signals, each signal representative of a component color value including a hue value, a saturation value, and an intensity value. For each component color value, an associated range of values is set. The ranges together define a non-rectangular subvolume in HSI color space. A determination is made whether each of the component values falls within the associated range of values. The signal is then outputting, indicating whether the pixel color value falls within the color range in response to each of the component values falling within the associated range of values. The range of values associated with the hue value comprises a range of values between a high hue value and a low hue value, the range of values associated with the saturation value comprises a range of values above a low saturation value, and the range of values associated with the intensity value comprises a range of values between a high intensity value and a low intensity value.

Such methods can be executed on an apparatus that can include a converter to convert a signal representative of a pixel color value to a plurality of signals representative of component color values including a hue value, a saturation value, and an intensity value. The hue comparator determines if the hue value falls within a first range of values. The apparatus can further include a saturation comparator to determine if the saturation value falls within a second range of values, as well as an intensity comparator to determine if the intensity value falls within a third range of values. In addition, a color identifier connected to each of the hue comparator, the saturation comparator, and the intensity comparator, is adapted to output a signal representative of a selected color range in response to the hue value falling within the first range of values, the saturation value falling within the second range of values, and the intensity value falling within the third range of values. The first range of values, the second range of values, and the third range of values define a non-rectangular subvolume in HSI color space, wherein the first range of values comprises a plurality of values between a low hue reference value and a high hue reference value, the second range of values comprises a plurality of values above a low saturation value, and the third range of values comprises a plurality of values between a low intensity value and a high intensity value.

In yet another approach, one could obtain color information by taking a single color channel from the optical sensing array. As an example, consider a blue channel, in which objects that are red are relatively dark. Objects which are blue, or white, are relatively light in the blue channel. In principle, one could take a single color channel, and simply set a threshold wherein everything darker than some threshold is categorized as a candidate object of interest, for example, a tumor cell, because it is red and hence dark in the channel being reviewed. However, one problem with the single channel approach occurs where illumination is not uniform. Non-uniformity of illumination results in non-uniformity across the pixel values in any color channel, for example, tending to peak in the middle of the image and dropping off at the edges where the illumination falls off. Performing thresholding on this non-uniform color information runs into problems, as the edges sometimes fall below the threshold, and therefore it becomes more difficult to pick the appropriate threshold level. However, with the ratio technique, if the values of the red channel fall off from center to edge, then the values of the blue channel also fall off center to edge, resulting in a uniform ratio at non-uniform lighting. Thus, the ratio technique is more immune to illumination.

As described, the color conversion scheme is relatively insensitive to changes in color balance, e.g., the relative outputs of the red, green, and blue channels. However, some control is necessary to avoid camera saturation, or inadequate exposures in any one of the color bands. This color balancing is performed automatically by utilizing a calibration slide consisting of a clear area, and a “dark” area having a known optical transmission or density. The system obtains images from the clear and “dark” areas, calculates “white” and “black” adjustments for the image-frame grabber or image processor 25, and thereby provides correct color balance.

In addition to the color balance control, certain mechanical alignments are automated in this process. The center point in the field of view for the various microscope objectives as measured on the slide can vary by several (or several tens of) microns. This is the result of slight variations in position of the microscope objectives 44a as determined by the turret 44 (FIG. 2 and 3), small variations in alignment of the objectives with respect to the system optical axis, and other factors. Since it is desired that each microscope objective be centered at the same point, these mechanical offsets must generally be measured and automatically compensated.

This is accomplished by imaging a test slide that contains a recognizable feature or mark. An image of this pattern is obtained by the system with a given objective, and the position of the mark determined. The system then rotates the turret to the next lens objective, obtains an image of the test object, and its position is redetermined. Apparent changes in position of the test mark are recorded for this objective. This process is continued for all objectives. Once these spatial offsets have been determined, they are automatically compensated for by moving the XY stage 38 by an equal (but opposite) amount of offset during changes in objective. In this way, as different lens objectives are selected, there is no apparent shift in center point or area viewed. A low pass filtering process precedes thresholding. An objective of thresholding is to obtain a pixel image matrix having only candidate cells or objects of interest, such as tumor cells above a threshold level and everything else below it. However, an actual acquired image will contain noise. The noise can take several forms, including white noise and artifacts. The microscope slide can have small fragments of debris that pick up color in the staining process and these are known as artifacts. These artifacts are generally small and scattered areas, on the order of a few pixels, which are above the threshold. The purpose of low pass filtering is to essentially blur or smear the entire color converted image. The low pass filtering process will smear artifacts more than larger objects of interest, such as tumor cells and thereby eliminate or reduce the number of artifacts that pass the thresholding process. The result is a cleaner thresholded image downstream. In the low pass filter process, a 3×3 matrix of coefficients is applied to each pixel in the X-image. A coefficient matrix is as follows:
1/9 1/9 1/9
1/9 1/9 1/9
1/9 1/9 1/9
   At each pixel location, a 3×3 matrix comprising the pixel of interest and its neighbors is multiplied by the coefficient matrix and summed to yield a single value for the pixel of interest. The output of this spatial convolution process is again a pixel matrix. As an example, consider a case where the center pixel and only the center pixel, has a value of 255 and each of its other neighbors, top left, top, top right and so forth, have values of 0.

This singular white pixel case corresponds to a small object. The result of the matrix multiplication and addition using the coefficient matrix is a value of ( 1/9)*255 or 28.3 for the center pixel, a value which is below the nominal threshold of 128. Now consider another case in which all the pixels have a value of 255 corresponding to a large object. Performing the low pass filtering operation on a 3×3 matrix for this case yields a value of 255 for the center pixel. Thus, large objects retain their values while small objects are reduced in amplitude or eliminated. In one method of operation, the low pass filtering process is performed on the X image twice in succession.

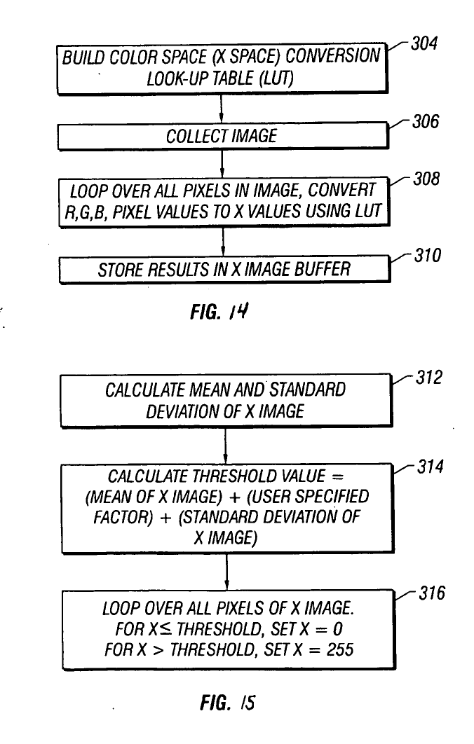

In order to separate objects of interest, such as a tumor cell in the x image from other objects and background, a thresholding operation is performed designed to set pixels within candidate cells or objects of interest to a value of 255, and all other areas to 0. Thresholding ideally yields an image in which cells of interest are white and the remainder of the image is black. A problem one faces in thresholding is where to set the threshold level. One cannot simply assume that cells of interest are indicated by any pixel value above the nominal threshold of 128. A typical imaging system can use an incandescent halogen light bulb as a light source. As the bulb ages, the relative amounts of red and blue output can change. The tendency as the bulb ages is for the blue to drop off more than the red and the green. To accommodate for this light source variation over time, a dynamic thresholding process is used whereby the threshold is adjusted dynamically for each acquired image. Thus, for each image, a single threshold value is derived specific to that image. As shown in FIG. 15, the basic method is to calculate, for each field, the mean X value, and the standard deviation about this mean 312. The threshold is then set at 314 to the mean plus an amount defined by the product of a factor (e.g., a user specified factor) and the standard deviation of the color converted pixel values. The standard deviation correlates to the structure and number of objects in the image. Typically, a user specified factor is in the range of approximately 1.5 to 2.5. The factor is selected to be in the lower end of the range for slides in which the stain has primarily remained within cell boundaries and the factor is selected to be in the upper end of the range for slides in which the stain is pervasively present throughout the slide. In this way, as areas are encountered on the slide with greater or lower background intensities, the threshold can be raised or lowered to help reduce background objects. With this method, the threshold changes in step with the aging of the light source such that the effects of the aging are canceled out. The image matrix resulting at 316 from the thresholding step is a binary image of black (0) and white (255) pixels. As is often the case with thresholding operations such as that described above, some undesired areas will lie above the threshold value due to noise, small stained cell fragments, and other artifacts. It is desired and possible to eliminate these artifacts by virtue of their small size compared with legitimate cells of interest. In one aspect, morphological processes are utilized to perform this function.

Morphological processing is similar to the low pass filter convolution process described earlier except that it is applied to a binary image. Similar to spatial convolution, the morphological process traverses an input image matrix, pixel by pixel, and places the processed pixels in an output matrix. Rather than calculating a weighted sum of the neighboring pixels as in the low pass convolution process, the morphological process uses set theory operations to combine neighboring pixels in a nonlinear fashion.

Erosion is a process whereby a single pixel layer is taken away from the edge of an object. Dilation is the opposite process, which adds a single pixel layer to the edges of an object. The power of morphological processing is that it provides for further discrimination to eliminate small objects that have survived the thresholding process and yet are not likely objects of interest (e.g., tumor cells). The erosion and dilation processes that make up a morphological “open” operation make small objects disappear yet allow large objects to remain. Morphological processing of binary images is described in detail in “Digital Image Processing”, pages 127-137, G. A. Baxes, John Wiley & Sons, (1994).

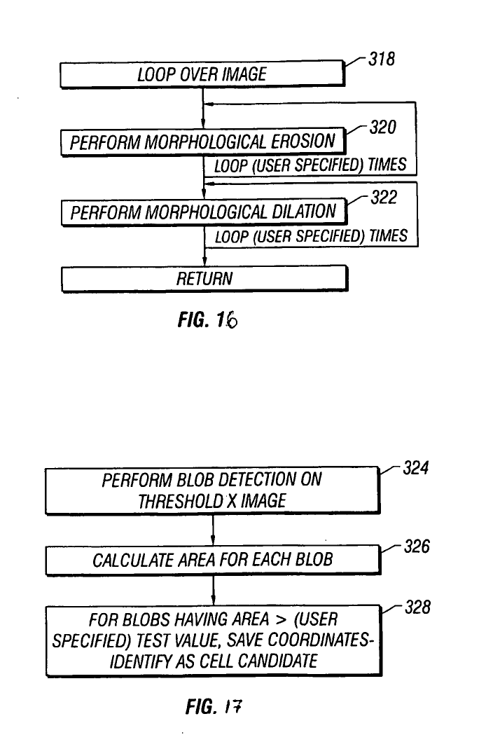

FIG. 16 illustrates the flow diagram for this process. A single morphological open consists of a single morphological erosion 320 followed by a single morphological dilation 322. Multiple “opens” consist of multiple erosions followed by multiple dilations. In one implementation, one or two morphological opens are found to be suitable. At this point in the processing chain, the processed image contains thresholded objects of interest, such as tumor cells (if any were present in the original image), and possibly some residual artifacts that were too large to be eliminated by the processes above.

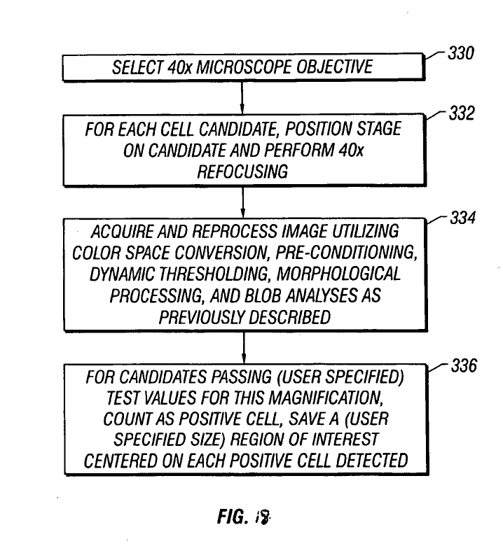

FIG. 17 provides a flow diagram illustrating a blob analysis performed to determine the number, size, and location of objects in the thresholded image. A blob is defined as a region of connected pixels having the same “color”, in this case, a value of 255. Processing is performed over the entire image to determine the number of such regions at 324 and to determine the area and coordinates for each detected blob at 326. Comparison of the size of each blob to a known minimum area at 328 for a tumor cell allows a refinement in decisions about which objects are objects of interest, such as tumor cells, and which are artifacts. The location of candidate cells or objects of interest identified in this process are saved for a higher magnification reimaging step described herein. Objects not passing the size test are disregarded as artifacts.

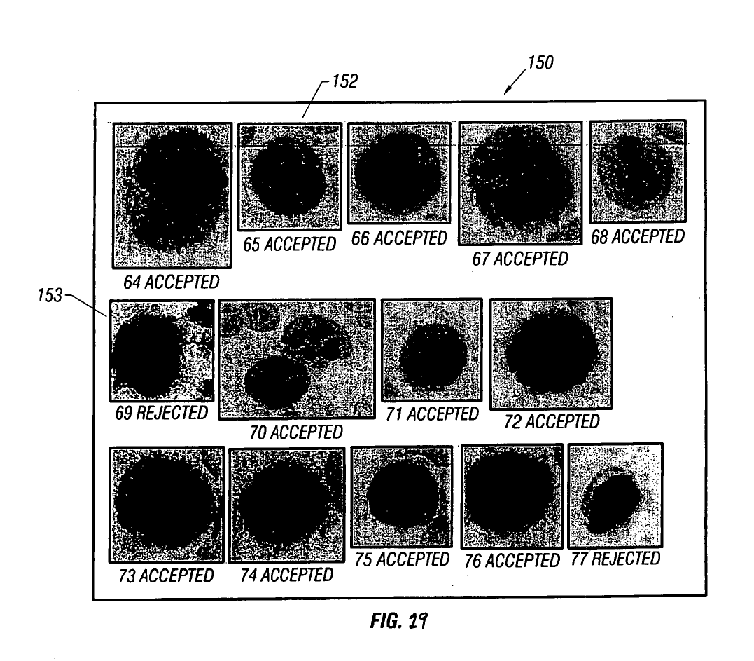

The processing chain described herein identifies candidate cells or objects of interest at a scanning magnification. As illustrated in FIG. 18, at the completion of scanning, the system switches to a higher magnification objective (e.g., 40×) at 330, and each candidate cell or object of interest is reimaged to confirm the identification 332. Each 40× image is reprocessed at 334 using the same steps as described above but with test parameters suitably modified for the higher magnification. At 336, a region of interest centered on each confirmed cell is saved to the hard drive for review by the pathologist.

Similarly, once imaging has been performed in transmitted and/or reflected light, imaging in fluorescent light can be performed using a process described above. For example, as illustrated in FIG. 18, at the completion of scanning and imaging at a higher magnification under transmitted light, the system switches from transmitted and/or reflected light to fluorescent excitation light and obtains images at a desired magnification objective (e.g., 40×) at 330, and each candidate cell or object of interest identified under transmitted and/or reflected light is reimaged under fluorescent light 332. Each fluorescent image is then processed at 334 but with test parameters suitably modified for the fluorescent imaging. At 336, fluorescent image comprising a fluorescently labeled object of interest is saved to storage device for review by a pathologist.

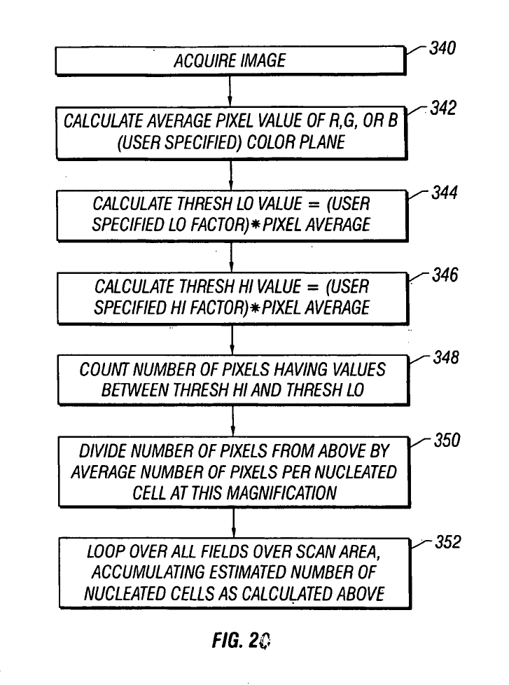

As noted earlier, a mosaic of saved images can be made available for review by a pathologist. As shown in FIG. 19, a series of images of cells that have been confirmed by the image analysis is presented in the mosaic 150. The pathologist can then visually inspect the images to make a determination whether to accept (152) or reject (153) each cell image. Such a determination can be noted and saved with the mosaic of images for generating a printed report. In addition, or alternatively an image of the entire sample or a substantially portion thereof can be made available based upon stitched together higher magnification images or a single low magnification image. In this aspect, candidate objects of interest can be readily apparent based upon color or morphology and can be further analyzed by clicking on an area near the candidate object of interest in the image.

In addition to saving an image of a candidate cell or object of interest, the coordinates are saved should the pathologist wish to directly view the cell through the oculars or on the image monitor. In this case, the pathologist reloads the slide carrier, selects the slide and cell for review from a mosaic of cell images, and the system automatically positions the cell under the microscope for viewing.

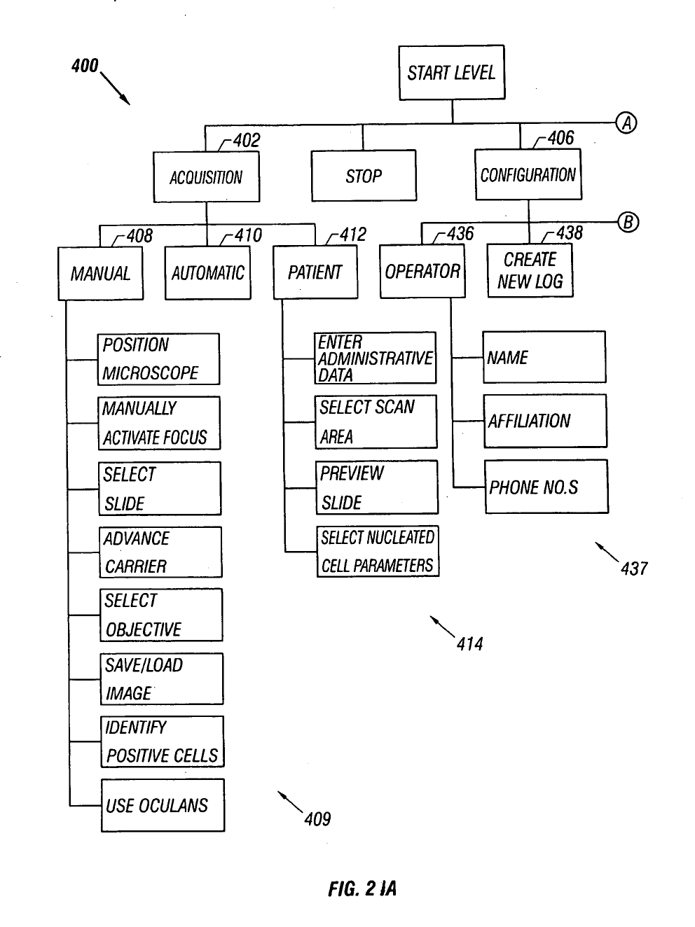

It has been found that normal cells whose nuclei have been stained with hematoxylin are often quite numerous, numbering in the thousands per 10× image. Since these cells are so numerous, and since they tend to clump, counting each individual nucleated cell would add an excessive processing burden, at the expense of speed, and would not necessarily provide an accurate count due to clumping. The apparatus performs an estimation process in which the total area of each field that is stained hematoxylin blue is measured and this area is divided by the average size of a nucleated cell. FIG. 20 outlines this process. In this process, an image is acquired 340, and a single color band (e.g., the red channel provides the best contrast for blue stained nucleated cells) is processed by calculating the average pixel value for each field at 342, thereby establishing two threshold values (high and low) as indicated at 344, 346, and counting the number of pixels between these two values at 348. In the absence of dirt, or other opaque debris, this provides a count of the number of predominantly blue pixels. By dividing this value by the average area for a nucleated cell at 350, and looping over all fields at 352, an approximate cell count is obtained. This process yields an accuracy of ±15%. It should be noted that for some slide preparation techniques, the size of nucleated cells can be significantly larger than the typical size. The operator can select the appropriate nucleated cell size to compensate for these characteristics.

As with any imaging system, there is some loss of modulation transfer (e.g., contrast) due to the modulation transfer function (MTF) characteristics of the imaging optics, camera, electronics, and other components. Since it is desired to save “high quality” images of cells of interest both for pathologist review and for archival purposes, it is desired to compensate for these MTF losses. An MTF compensation (MTFC) is performed as a digital process applied to the acquired digital images. A digital filter is utilized to restore the high spatial frequency content of the images upon storage, while maintaining low noise levels. With this MTFC technology, image quality is enhanced, or restored, through the use of digital processing methods as opposed to conventional oil-immersion or other hardware based methods. MTFC is described further in “The Image Processing Handbook,” pages 225 and 337, J. C. Rues, CRC Press (1995).

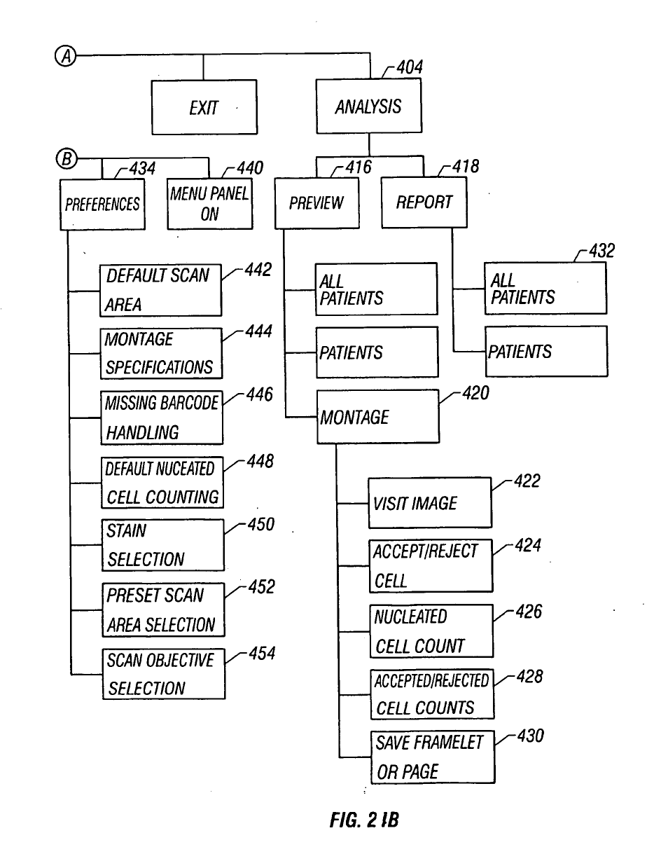

Referring to FIG. 21A-B, exemplary functions available in a user interface of the apparatus 10 are shown. From the user interface, which is presented graphically on computer monitor 26, an operator can select among apparatus functions that include acquisition 402, analysis 404, and configuration 406. At the acquisition level 402, the operator can select between manual 408 and automatic 410 modes of operation. In the manual mode, the operator is presented with manual operations 409. Patient information 414 regarding an assay can be entered at 412. In the analysis level 404, preview 416 and report 418 functions are made available. At the preview level 416, the operator can select a montage function 420. At this montage level, a pathologist can perform diagnostic review functions including visiting an image 422, accept/reject a cell 424, nucleated cell counting 426, accept/reject cell counts 428, and saving of pages 430. The report level 418 allows an operator to generate patient reports 432. In the configuration level 406, the operator can select to configure preferences 434, input operator information 436 including Name, affiliation and phone number 437, create a system log 438, and toggle a menu panel 440. The configuration preferences include scan area selection functions 442 and 452; montage specifications 444, bar code handling 446, default cell counting 448, stain selection 450, and scan objective selection 454.

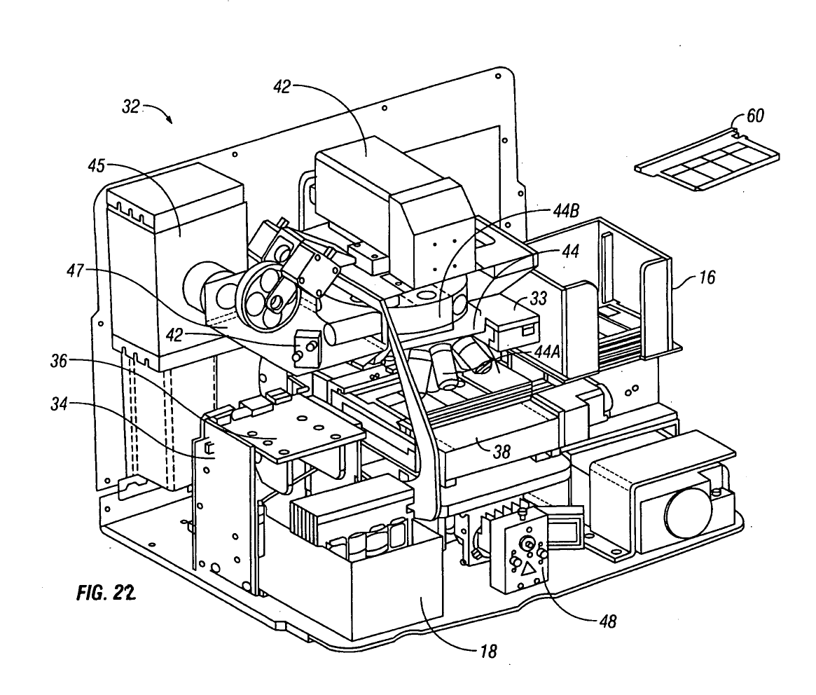

An exemplary microscope subsystem 32 for processing fluorescently labeled samples is shown in FIG. 22. A carrier 60 having four slides thereon is shown. The number of slide in different implementations can be greater than or less than four. An input hopper 16 for carriers with mechanisms to load a carrier 60 onto the stage at the bottom. Precision XY stage 38 with mechanism to hold carriers is shown. A turret 44 with microscope objective lenses 44a mounted on z axis stage is shown. Carrier outfeed tray 36 with mechanism 34 to drop carriers into slide carrier output hopper 18. The slide carrier output hopper 18 is a receptacle for those slides that have already been scanned. Bright field (transmission) light source 48 and fluorescent excitation light source 45 are also shown. Filter wheels 47 for fluorescent light path are shown, as well as a fold mirror 47a in the fluorescent light path. A bar code/OCR reader 33 is shown. Also shown are a computer-controlled wheel 44b carrying fluorescent beam splitters (one position is empty for bright field mode) and a camera 42 capable of collecting both bright field (video rate) images and fluorescent (integrated) images.

The automated detection of fluorescent specimens can be performed using a single slide or multiple slides. In using a single slide, the initial scan or imaging, under lower power and transmitted and/or reflected light, can be performed on the same slide as the one from which the fluorescent images will be obtain. In this case, the coordinates of any identified candidate objects of interest do not need to be corrected. Fluorescent images can also be collected from multiple serial sections. For example, in situations where more than one fluorescent study is desired for a particular tissue, different studies can be carried out on adjacent sections placed on different slides. The slides of the different studies can be analyzed at high resolution and/or fluorescence from data collected from the initial scan of the first slide. In using adjacent tissue sections on multiple slides, however, it is desirable to orient the sections so that the specimens will correlate from one section to the other(s). This can be done by using landmarks, such as at least two unique identifiers or distinctive features, or outlining the tissue. Algorithms are known that can be used to calculate a location on the second or additional slides that can be mapped to any given location of the first slide. Examples of such algorithms are provided herein and include techniques as disclosed in U.S. Pat. Nos. 5,602,937 and 6,272,247, the disclosures of which are incorporated herein by reference in their entirety. In addition, such computer algorithms are commercially available from Matrox Electronic Systems Ltd. (Matrox Imagining Library (MIL) release 7.5).

Regardless of whether a single slide or multiple slides are used in the analysis, methods of selecting relevant regions of the slide for analysis are needed. It is desirable that the method be sufficiently selective so that time will not be wasted collecting images that the user never scores or includes in the report. However, it is also desirable that the method not be too selective, as the user can see a region that seems important in the bright field image and find that there is no high power. fluorescent image in that region. Examples of methods for selecting the regions of the slide for fluorescing and/or high power magnification are provided.

A hematoxylin/eosin (H/E) slide is prepared with a standard H/E protocol. Standard solutions include the following: (1) Gills hematoxylin (hematoxylin 6.0 g; aluminum sulphate 4.2 g; citric acid 1.4 g; sodium iodate 0.6 g; ethylene glycol 269 ml; distilled water 680 ml); (2) eosin (eosin yellowish 1.0 g; distilled water 100 ml); (3) lithium carbonate 1% (lithium carbonate 1 g.; distilled water 100 g); (4) acid alcohol 1% 70% (alcohol 99 ml conc.; hydrochloric acid 1 ml); and (5) Scott's tap water. In a beaker containing 1 L distilled water, add 20 g sodium bicarbonate and 3.5 g magnesium sulphate. Add a magnetic stirrer and mix thoroughly to dissolve the salts. Using a filter funnel, pour the solution into a labeled bottle.

The staining procedure is as follows: (1) bring the sections to water; (2) place sections in hematoxylin for 5 min; (3) wash in tap water; (4) ‘blue’ the sections in lithium carbonate or Scott's tap water; (5) wash in tap water; (6) place sections in 1% acid alcohol for a few seconds; (7) wash in tap water; (8) place sections in eosin for 5 min; (9) wash in tap water; and (10) dehydrate, clear mount sections. The results of the H/E staining provide cells with nuclei stained blue-black, cytoplasm stained varying shades of pink; muscle fibers stained deep pinky red; fibrin stained deep pink; and red blood cells stained orange-red.

In another aspect, microvessel density analysis can be performed and a determination of any cytokines, angiogenic reagents, and the like, which are suspected of playing a role in the angiogenic activity identified. Angiogenesis is a characteristic of growing tumors. By identifying an angiogenic reagent that is expressed or produced aberrantly compared to normal tissue, a therapeutic regimen can be identified that targets and modulates (e.g., increases or decreases) the angiogenic molecule or combination of molecules. For example, endothelial cell proliferation and migration are characteristic of angiogenesis and vasculogenesis. Endothelial cells can be identified by markers on the surface of such endothelial cells using a first reagent that labels endothelial cells. An automated microscope system (such as that produced by ChromaVision Medical Systems, Inc., California) scans the sample for objects of interest (e.g., endothelial cells) stained with the first reagent. The automated system then determines the coordinates of an object of interest and uses these coordinates to focus in on the sample or a subsample that has been contacted with a second fluorescently labeled reagent. In one aspect, a second reagent (e.g., an antibody, polypeptide, and/or oligonucleotide) that is labeled with a fluorescent indicator is then used to detect the specific expression or presence of any number of angiogenic reagents.

One method of sample preparation is to react a sample or subsample with an reagent the specifically interacts with a molecule in the sample. Examples of such reagents include a monoclonal antibody, a polyclonal antiserum,l or an oligonucleotide or polynucleotide. Interaction of the reagent with its cognate or binding partner can be detected using an enzymatic reaction, such as alkaline phosphatase or glucose oxidase or peroxidase to convert a soluble colorless substrate linked to the reagent to a colored insoluble precipitate, or by directly conjugating a dye or a fluorescent molecule to the probe. In one aspect, a first reagent is labeled with a non-fluorescent label (e.g., a substrate that gives rise to a precipitate) and a second reagent is labeled with a fluorescent label. If the same sample is to be used for both non-fluorescent detection and fluorescent detection, the non-fluorescent label should not interfere with the fluorescent emissions from the fluorescent label. Examples of non-fluorescent labels include enzymes that convert a soluble colorless substrate to a colored insoluble precipitate (e.g., alkaline phosphatase, glucose oxidase, or peroxidase). Other non-fluorescent reagent include small molecule reagents that change color upon interaction with a particular chemical structure.

In one aspect of Fluorescent in Situ Hybridization (FISH), a fluorescently labeled oligonucleotide (e.g., DNA, RNA, and DNA-RNA hybrid molecule) is used as a reagent. The fluorescently labeled oligonucleotide is contacted with a sample on a microscope slide. If the labeled oligonucleotide is complementary to a target nucleotide sequence in the sample on the slide, a bright spot will be seen when visualized on a microscope system comprising a fluorescent excitation light source. The intensity of the fluorescence will depend on a number of factors, such as the type of label, reaction conditions, amount of target in the sample, amount of oligonucleotide reagent, and amount of label on the oligonucleotide reagent. There are a number of methods, known in the art, that can be used to increase the amount of label attached to an reagent in order to make the detection easier. FISH has an advantage that individual cells containing a target nucleotide sequences of interest can be visualized in the context of the sample or tissue sample. As mentioned above, this can be important in testing for types of diseases and disorders including cancer in which a cancer cell might penetrate normal tissues.

A number of implementations have been described. Nevertheless, it will be understood that various modifications may be made. Accordingly, other implementations are within the scope of the following claims.

What is claimed is:

1. A method for identifying endothelial cells, endothelial progenitor cells, or fragments thereof in a biological sample, comprising:
(a) contacting a biological sample with at least one reagent that stains one or more structures or markers associated with an endothelial cell or endothelial cell progenitor;
(b) automatically acquiring one or more images of the biological sample under a desired illumination scheme;
(c) automatically processing the one or more images to identify a stained object of interest;
(d) automatically determining a coordinate for the identified stained object of interest;
(e) automatically storing determined coordinates and corresponding images for the identified stained object of interest; and
(f) automatically providing a report comprising a summary of (e).

2. The method of claim 1, wherein the biological sample is a fluid sample.

3. The method of claim 2, wherein the fluid sample is suspected of comprising cells having a cell proliferative disorder.

4. The method of claim 3, wherein the cell proliferative disorder is a neoplasm.

5. The method of claim 1, wherein the at least one reagent comprises a stain selected from the group consisting of DAB, New Fuchsin, AEC, and hematoxalin.

6. The method of claim 5, wherein the object of interest is a cell.

7. The method of claim 5, wherein the object of interest is a nucleus of a cell.

8. The method of claim 1, wherein the at least one reagent is an antibody.

9. The method of claim 8, wherein the antibody specifically interacts with a marker selected from the group consisting of VE Cadherin (CD144), Von Willibrand Factor, thrombomodulin (CD141), and PAL-E.

10. The method of claim 8, wherein the antibody specifically interacts with a marker selected from the group consisting of PECAM-1 (CD31), CD146, VEGF Receptor-1 (FLT-1), VEGF Receptor-2 (FLK-1, KDR), VEGF RECEPTOR-3 (FLT-4), TIE-1, TIE-2, CD34, ICAM-1 (CD54), p-Selectin GMP140 (CD62P), and Endoglin CD105.

11. The method of claim 8, wherein the antibody is enzymatically labeled.

12. The method of claim 8, wherein the antibody is fluorescently labeled.

13. The method of claim 1, wherein the one or more images are acquired at a low or a high magnification.

14. The method of claim 1, parts (b)-(f) implemented on a data processing device.

15. A computer program on a computer-readable medium, comprising instructions for a data processing device to carry out the method of claim 1, parts (b)-(f).
